(19) United States
(12) Patent Application Publication
(10) Pub. No.: US 2026/0113631 A1
(43) Pub. Date: Apr. 23, 2026

(54) DATA COMMUNICATION

(71) Applicant: NICOVENTURES TRADING LIMITED, London (GB)

(72) Inventors: Roberto PELLEGRINI, London (GB); Darryl BAKER, London (GB); Massimiliano GALANTI, London (GB); Robert KERSEY, London (GB)

(21) Appl. No.: 19/119,859

(22) PCT Filed: Oct. 11, 2023
(86) PCT No.: PCT/EP2023/078239

§ 371 Date: Apr. 10, 2025

(30) Foreign Application Priority Data
Oct. 11, 2022 (GB) 2214984.3

(51) Int. Cl. H04W 12/08; A24F 40/53; A24F 40/65; H04L 47/43

(52) U.S. Cl. CPC H04W 12/08; A24F 40/53; A24F 40/65; H04L 47/43

(57) ABSTRACT

There is provided herein a method for transmitting a payload using a connectionless state packet, the method comprising: obtaining, by a device having a capability for connectionless state advertising, a payload that exceeds a maximum payload size of a connectionless state advertising packet; determining, by the device, a plurality of payload chunks from the payload, each payload chunk having a size less than the maximum payload size; transmitting, by the device in an advertising mode, a plurality of connectionless state advertising packets, each connectionless state advertising packet including a chunk of the plurality of chunks, and an identifier of the chunk number.

### BACKGROUND

The present disclosure relates to data communication and in particular but not exclusively to a method and apparatus for communication from an aerosol delivery device using connectionless state communication.

In the use of aerosol delivery devices such as electronic nicotine delivery (END) devices or aerosol provision devices (sometimes known as e-cigarettes), it may be appropriate to prevent or impede unauthorised users from using a device. In examples, such as Juul C1, unauthorised users can be prevented or impeded from using such a device by the use of locking systems on such delivery devices. Physical locking systems are possible but may in some instances be overridden by basic determined physical access attempts. Other locking systems may use software-based locking systems, such that the device can directly or indirectly ascertain whether the user is authorised or not before enabling the usage of the device for nicotine delivery and/or aerosol generation.

Storing of the authorisation data relating to the user is a concern. Such details may be sensitive, for example those identifying the user such as those containing age data of a user. As such, it may be appropriate to avoid holding the details on the aerosol provision device to reduce a risk of the information being accessed by hackers attempting to compromise the device.

Furthermore, modern locking and unlocking operations may include requirements such as pairing an aerosol provision device (or the like) to a mobile device (or the like) for confirming the user. Such operations may be resource intensive and require strong and reliable connections between the two pairing devices. If the connection is severed, the locking or unlocking operation may fail and require further connection attempts.

Improvements to locking and unlocking operations are disclosed herein.

Approaches of transferring data using low power communications protocols such as Bluetooth™ or Bluetooth Low Energy (referred to in shorthand as BLE), also known as Bluetooth Smart, often involve establishing a partnership, bonding, pairing or other connection-based channel between two entities to facilitate transmitting information over that protocol. Via this connection-based channel, small payloads may be transmitted and utilised by the receiving device.

Communication on such protocols can occur between, for example, a personal device and an aerosol provision device. The communication may therefore not include communication to a reliable secure data store, such as belonging to the manufacturer of the aerosol provision device.

Viewed from one perspective, there can be provided a connection-less communication for transmitting large payloads.

Techniques described herein also utilise trusted sources to ensure that both the transmission of large payloads, and the large payloads themselves may be trusted.

US20161/84635 describes a method and apparatus for transmitting and receiving data using Bluetooth. US2013/065584 describes low energy beacon encoding. TW201513524A describes monitoring system of physiological information following Bluetooth low energy protocol. US2015319555 describes method and apparatus for Bluetooth-based Wi-Fi synchronization. US2015/172391 describes method, apparatus and computer program product for network discovery. US2016/029149 describes lower power consumption short range wireless communication system. WO16/037012A describes measuring health and fitness data using proximity sensors and mobile technologies. US20168021448 describes range management with Bluetooth low energy. US2015/312858 describes method and apparatus for generating a Bluetooth low energy data packet comprising audio payload. US2016/037566 describes method and system for optimized Bluetooth low energy communications. US2011/021142 describes method and system for a dual-mode Bluetooth low energy device. US2013/178160 describes systems for facilitating wireless communication and related methods. WO16/108646A describes method and apparatus for controlling device using Bluetooth LE technique. WO16/017909A describes method and apparatus for controlling electronic device in wireless communication system supporting Bluetooth communication. CN104664605A describes intelligent electronic cigarette with wireless Bluetooth low-power-consumption communication function.

### SUMMARY

Particular aspects and embodiments are set out in the appended independent and dependent claims.

Viewed from one perspective, there can be provided a method for providing an unlock signal to a locked device.

In a particular approach, there can be provided a method for providing an unlock signal to a locked device, the method comprising: transmitting, by a user device operating in a wireless advertising mode, an advertising packet containing data requesting an unlock of a locked device; receiving, by the user device operating in a wireless scanning mode, an advertising packet containing an unlock challenge request from the locked device; obtaining, by the user device and from an unlock certification entity, a signed unlock message; and transmitting, by the user device operating in the wireless advertising mode, an advertising packet containing data comprising the signed unlock message.

In an example, the advertising packets are connectionless state packets. In an example, the transmitting and receiving steps occur via Bluetooth or Bluetooth Low Energy, BLE. In an example, the advertising mode is BLE peripheral mode. In an example, the scanning mode is BLE central mode. In an example, each transmitting step is performed multiple times. In an example, the data requesting an unlock of a locked device comprises a predetermined code to identify the payload as a message relating to unlocking of a locked device having a device type corresponding to a device type of the locked device. In an example, the data requesting an unlock of a locked device comprises a code generated to distinguish the advertising packets from advertising packets generated by another user device or another locked device. In an example, the data requesting an unlock of a locked device is larger than payload of a single advertising packet. In an example, the data requesting an unlock of a locked device is divided over multiple advertising packets using approach provided by operating service or via wireless implementation of the user device. In an example, the data requesting an unlock of a locked device is divided over multiple advertising packets using a 128 bits UUID message. In an example, the unlock challenge request from the locked device comprises a predetermined code to identify the payload as a message relating to unlocking of a locked device having a device type corresponding to a device type of the locked device. In an example, the unlock challenge request from the locked device comprises a code generated to distinguish the advertising packets from advertising packets generated by another user device or another locked device. In an example, the unlock challenge request from the locked device fits within payload of a single advertising packet. In an example, the unlock challenge request from the locked device fits within payload of a two advertising packets. In an example, the unlock challenge request from the locked device is larger than payload of a single advertising packet. In an example, the unlock challenge request from the locked device is divided over multiple advertising packets using an approach provided by one of an operating system or a wireless implementation of the user device. In an example, the unlock challenge request from the locked device is divided over multiple advertising packets using a 128 bits UUID message. In an example, obtaining a signed unlock message comprises sending a request to the unlock certification entity and receiving from the unlock certification entity the signed unlock message. In an example, obtaining the signed unlock message is performed over computing network connection between user device and unlock certification entity. In an example, the unlock certification entity is an age verification service entity. In an example, data comprising the signed unlock message comprises a predetermined code to identify the payload as a message relating to unlocking of a locked device having a device type corresponding to a device type of the locked device. In an example, data comprising the signed unlock message comprises the code generated to distinguish the advertising packets from advertising packets generated by another user device or another locked device. In an example, data comprising the signed unlock message is larger than a payload of a single advertising packet. In an example, data comprising the signed unlock message is divided over multiple advertising packets using an approach provided by one of an operating system or a wireless implementation of the user device. In an example, data comprising the signed unlock message is divided over multiple advertising packets using a 128 bits UUID message. In an example, the locked device is an aerosol generation device. In an example, the user device is at least one of a: smartphone; a smart device; and, a personal computer. In an example, the method further comprises entering a device unlock mode at the user device before transmitting the advertising packet containing data requesting an unlock of a locked device. In an example, the method further comprises entering a device pairing mode after transmitting the advertising packet containing data comprising the signed unlock message. In an example, the method further comprises upon receipt of n chunks of a payload of n chunks: generating a challenge request; and, changing mode from advertising mode to scanning mode. In an example, the method further comprises upon receipt of challenge request changing mode from scanning to advertising.

In a particular approach, there can be provided a method of receiving an unlock signal by a locked device, the method comprising: receiving, by a locked device operating in a wireless scanning mode, an advertising packet containing data requesting an unlock of a locked device; transmitting, by a locked device operating in a wireless advertising mode, an advertising packet containing an unlock challenge request from the locked device; receiving, by the locked device operating in a wireless scanning mode, an advertising packet containing data comprising a signed unlock message.

In an example, the advertising packets are connectionless state packets. In an example, the transmitting and receiving steps occur via Bluetooth or Bluetooth Low Energy, BLE. In an example, the advertising mode is BLE peripheral mode. In an example, the scanning mode is BLE central mode. In an example, each receiving step is performed multiple times. In an example, the data requesting an unlock of a locked device comprises a predetermined code to identify the payload as a message relating to unlocking of a locked device having a device type corresponding to a device type of the locked device. In an example, the data requesting an unlock of a locked device comprises a code generated to distinguish the advertising packets from advertising packets generated for another locked device. In an example, the data requesting an unlock of a locked device is larger than payload of a single advertising packet. In an example, the data requesting an unlock of a locked device is divided over multiple advertising packets using approach provided by operating service or via wireless transmission. In an example, the data requesting an unlock of a locked device is divided over multiple advertising packets using a 128 bits UUID message. In an example, data comprising the signed unlock message comprises a predetermined code to identify the payload as a message relating to unlocking of a locked device having a device type corresponding to a device type of the locked device. In an example, data comprising the signed unlock message comprises the code generated to distinguish the advertising packets from advertising packets generated for another locked device. In an example, data comprising the signed unlock message is larger than a payload of a single advertising packet. In an example, data comprising the signed unlock message is divided over multiple advertising packets using an approach provided by one of an operating system or via wireless transmission. In an example, data comprising the signed unlock message is divided over multiple advertising packets using a 128 bits UUID message. In an example, the locked device is an aerosol generation device. In an example, receiving, by a locked device operating in a wireless scanning mode, an advertising packet containing data requesting an unlock of a locked device, comprises: receiving, by a locked device operating in a wireless scanning mode from a user device operating in a wireless advertising mode, an advertising packet containing data requesting an unlock of a locked device, and the user device is at least one of a: smartphone; a smart device; and, a personal computer. In an example, the method further comprises entering a device unlock mode at the user device before transmitting the advertising packet containing data requesting an unlock of a locked device. In an example, the method further comprises entering a device pairing mode after receiving the advertising packet containing data comprising the signed unlock message. In an example, the method further comprises upon receipt of n chunks of a payload of n chunks: generating a challenge request; and, changing mode from advertising mode to scanning mode. In an example, the method further comprises upon receipt of challenge request changing mode from scanning to advertising.

In a particular approach, there can be provided a method for providing an unlock signal to a locked device, the method comprising: transmitting, by a user device operating in a wireless advertising mode, to a locked device operating in a wireless scanning mode, an advertising packet containing data requesting an unlock of a locked device; receiving, by the user device operating in a wireless scanning mode, from a locked device operating in a wireless advertising mode, an advertising packet containing an unlock challenge request; obtaining, by the user device from an unlock certification entity, a signed unlock message; and transmitting, by the user device operating in the wireless advertising mode, to a locked device operating in a wireless scanning mode, an advertising packet containing data comprising the signed unlock message.

Viewed from a perspective, there can be provided a device.

In a particular approach, there can be provided a user device comprising a wireless communication interface configured to transmit, a connectionless-state advertising packet containing data requesting an unlock of a locked device; the wireless communication interface further configured to receive a connectionless-state advertising packet from the locked device containing an unlock challenge request; and the wireless communication interface further configured to: obtain, from an unlock certification entity, a signed unlock message; and transmit a connectionless-state advertising packet containing data comprising the signed unlock message.

In a particular approach, there can be provided a locked device comprising: a wireless communication interface configured to receive, a connectionless-state advertising packet containing data requesting an unlock of the locked device; the wireless communication interface further configured to transmit a connectionless-state advertising packet containing an unlock challenge request to the user device; and the wireless communication interface further configured to: receive a connectionless-state advertising packet containing data comprising a signed unlock message.

In an example, the locked device is an aerosol generation device.

Viewed from a perspective, there can be provided a system.

In a particular approach, there can be provided a system comprising: a user device comprising a wireless communication interface; a locked device comprising a wireless communication interface; an unlock certification entity; wherein the system is configured to: send, from the user device operating in a wireless advertising mode to the locked device operating in a wireless scanning mode, a connectionless-state advertising packet containing data requesting an unlock of the locked device; send, from the locked device operating in a wireless advertising mode to the user device operating in a wireless scanning mode, a connectionless-state advertising packet containing an unlock challenge request to the locked device; receive, by the user device operating in a wireless scanning mode from the unlock certification entity, a signed unlock message; send, from the user device operating in a wireless advertising mode to the locked device operating in a wireless scanning mode, a connectionless-state advertising packet containing data comprising the signed unlock message.

Viewed from a perspective, there can be provided a computer readable medium.

In a particular approach, there can be provided a computer readable medium comprising instructions that, when executed by a computer processor, perform any of the above methods.

Viewed from a perspective, there can be provided a method for transmitting a payload using a connectionless state packet.

In a particular approach, there can be provided a method for transmitting a payload using a connectionless state packet, the method comprising: obtaining, by a device having a capability for connectionless state advertising, a payload that exceeds a maximum payload size of a connectionless state advertising packet; determining, by the device, a plurality of payload chunks from the payload, each payload chunk having a size less than the maximum payload size; transmitting, by the device in an advertising mode, a plurality of connectionless state advertising packets, each connectionless state advertising packet including a chunk of the plurality of chunks, and an identifier of the chunk number.

In an example, each connectionless state advertising packet further comprises a code that identifies the packet as a packet conveying a payload chunk of the payload. In an example, each connectionless state advertising packet further comprises a number identifying the total number of payload chunks. In an example, each connectionless state advertising packet further comprises a code generated to distinguish the advertising packets from advertising packets generated by another device. In an example, each of the plurality of connectionless state packets comprises transmitting each of the plurality of connectionless state packets plural times. In an example, the method further comprises entering a scanning mode to receive a response from a recipient device of the connectionless state packets. In an example, the method further comprises receiving, by the device in a scanning mode, a response from a recipient device of the connectionless state packets. In an example, the response, received by the device in scanning mode, comprises: a payload that exceeds a maximum payload size of a connectionless state advertising packet, wherein the payload comprises: a plurality of payload chunks, each payload chunk having a size less than the maximum payload size. In an example, each connectionless state advertising packet of the response further comprises a code that identifies the packet as a packet conveying a payload chunk of the payload. In an example, each connectionless state advertising packet of the response further comprises a number identifying the total number of payload chunks. In an example, the received packets of the response are rebuilt by the device in scanning mode based on data comprising a payload chunk number of the packet. In an example, wherein, responsive to receiving the response, receiving further responses from the recipient device of the connectionless state packets. In an example, the device is an aerosol provision device.

In a particular approach, there can be provided a method for transmitting a payload using a connectionless state packet, the method comprising: obtaining, by a first device having a capability for connectionless state advertising, a payload that exceeds a maximum payload size of a connectionless state advertising packet, determining, by the first device, a plurality of payload chunks from the payload, each payload chunk having a size less than the maximum payload size; transmitting, by the first device in an advertising mode to a second device in a scanning mode, a plurality of connectionless state advertising packets, each connectionless state advertising packet including a chunk of the plurality of chunks, and an identifier of the chunk number.

In an example, each connectionless state advertising packet further comprises a code that identifies the packet as a packet conveying a payload chunk of the payload from the first device to the second device. In an example, each connectionless state advertising packet further comprises a number identifying the total number of payload chunks. In an example, each connectionless state advertising packet further comprises a code generated to distinguish the advertising packets from advertising packets generated by another device. In an example, transmitting each of the plurality of connectionless state packets, by the first device in an advertising mode, comprises transmitting each of the plurality of connectionless state packets plural times. In an example, the method further comprises entering a scanning mode to receive a response from the second device. In an example, the method further comprises responsive to receiving the plurality of payload chunks and rebuilding the plurality of payload chunks into the payload, entering, by the second device, an advertising mode, transmitting, by the second device, a response to the payload to the first device, receiving, by the first device in a scanning mode, a response from the second device. In an example, the response to the payload exceeds a maximum payload size of a connectionless state advertising packet, the method further comprising: determining, by the second device, a plurality of response payload chunks for the response payload, each response payload chunk having a size less than the maximum payload size; transmitting, by the second device in an advertising mode to the first device in a scanning mode, a plurality of response connectionless state advertising packets, each response connectionless state advertising packet including a chunk of the plurality of chunks, and an identifier of the chunk number.

Viewed from a perspective, there can be provided a device for transmitting a payload using a connectionless state packet.

In a particular approach, there can be provided a device for transmitting a payload using a connectionless state packet comprising: a wireless communication interface, the wireless communication interface configured to: receive a payload that exceeds a maximum payload size of a connectionless state advertising packet; determine a plurality of payload chunks from the payload, each payload chunk having a size less than the maximum payload size; and transmit, by the device in an advertising mode, a plurality of connectionless state advertising packets, each connectionless state advertising packet including a chunk of the plurality of chunks, and an identifier of the chunk number.

Viewed from a perspective, there can be provided a device for receiving a payload using a connectionless state packet.

In a particular approach, there can be provided a device for receiving a payload using a connectionless state packet comprising: a wireless communication interface, the wireless communication interface configured to: receive, in a scanning mode, a plurality of connectionless state advertising packets, each connectionless state advertising packet including a chunk of the plurality of chunks, and an identifier of the chunk number, rebuild the received plurality of connectionless state advertising packets based on data comprising a payload chunk number of the packet.

Viewed from a perspective, there can be provided a system.

In a particular approach, there can be provided a system comprising: a first device comprising a wireless communication interface; and, a second device comprising a wireless communication interface; wherein the system is configured to: receive a payload, by the first device, that exceeds a maximum payload size of a connectionless state advertising packet; determine, by the first device, a plurality of payload chunks from the payload, each payload chunk having a size less than the maximum payload size; transmit, by the first device in an advertising mode to the second device in a scanning mode, a plurality of connectionless state advertising packets, each connectionless state advertising packet including a chunk of the plurality of chunks, and an identifier of the chunk number; receive, by the second device in a scanning mode, the plurality of connectionless state advertising packets, each connectionless state advertising packet, rebuild, by the second device in a scanning mode, the received plurality of connectionless state advertising packets based on data comprising a payload chunk number of the packet.

Viewed from a perspective, there can be provided a computer readable medium.

In a particular approach, there can be provided a computer readable medium comprising instructions that, when executed by a computer processor, perform any of the above methods.

Viewed from a perspective, there can be provided a method for providing an unlock signal to a locked device, the method comprising: transmitting, by a user device operating in a wireless advertising mode, an advertising packet containing data requesting an unlock of a locked device; receiving, by the user device operating in a wireless scanning mode, an advertising packet containing an unlock challenge request from the locked device.

In an example, the locked device is an aerosol provision device. In an example, the user device is a mobile communication device.

In some example, the aerosol delivery device is an electronic nicotine delivery device. Thereby an electronic nicotine delivery device and user may benefit from the techniques described herein.

### BRIEF DESCRIPTION OF FIGURES

Embodiments of the present teachings will now be described, by way of example only, with reference to accompanying drawings, in which:

FIG. 1 schematically illustrates an advertising protocol;

FIG. 2 schematically illustrates an example devices environment;

FIG. 3 schematically illustrates a method for an unlock operation;

FIG. 4 schematically illustrates a messaging sequence relating to an unlock operation;

FIG. 5 schematically illustrates a detailed view of portion A of the messaging sequence of FIG. 4;

FIG. 6 schematically illustrates a detailed view of portion B of the messaging sequence of FIG. 4;

FIG. 7 schematically illustrates a method for an unlock operation

FIG. 8 schematically illustrates a method for an unlock operation;

FIG. 9 schematically illustrates a messaging sequence relating to an unlock operation;

FIG. 10 schematically illustrates a detailed view of portion C of the messaging sequence of FIG. 9;

FIG. 11 schematically illustrates a method for an unlock operation;

FIG. 12 schematically illustrates a messaging sequence for a phone (user device) and a device (locked device) to communicate;

FIG. 13 schematically illustrates a messaging sequence relating to an unlock operation for a system comprising a user device, certification entity and a locked device;

FIG. 14 schematically illustrates a method for transmitting a payload;

FIG. 15 schematically illustrates a method for transmitting a payload;

FIG. 16 schematically illustrates a method for receiving a payload; and,

FIG. 17 schematically illustrates a message undergoing a chunking method described herein.

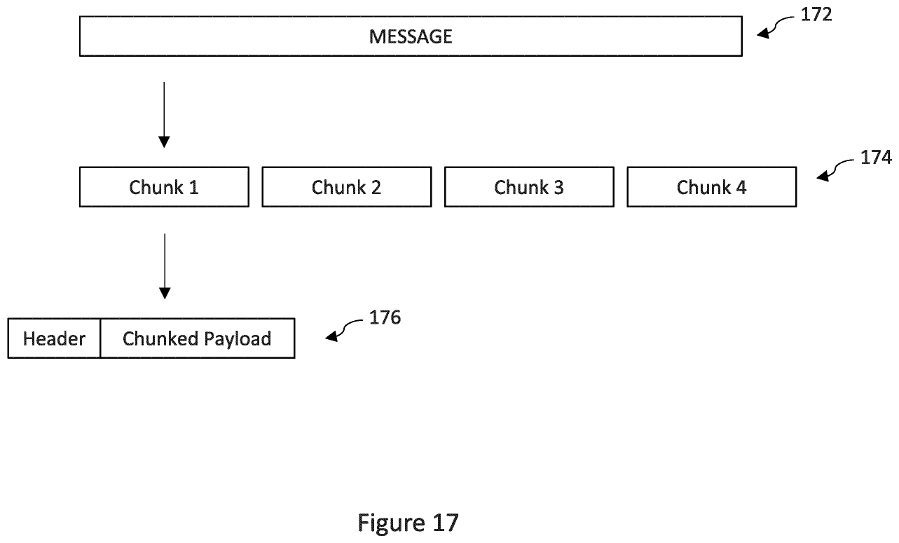

While the presently described approach is susceptible to various modifications and alternative forms, specific embodiments are shown by way of example in the drawings and are herein described in detail. It should be understood, however, that drawings and detailed description thereto are not intended to limit the scope to the particular form disclosed, but on the contrary, the scope is to cover all modifications, equivalents and alternatives falling within the spirit and scope as defined by the appended claims.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to aerosol provision systems, which may also be referred to as aerosol provision systems, such as e-cigarettes. Throughout the following description the term “e-cigarette” or “electronic cigarette” may sometimes be used, but it will be appreciated this term may be used interchangeably with aerosol provision system/device and electronic aerosol provision system/device. Furthermore, and as is common in the technical field, the terms “aerosol” and “vapour”, and related terms such as “vaporise”, “volatilise” and “aerosolise”, may generally be used interchangeably.

The present disclosure relates to a modified form of wireless communication behaviour. According to the present teachings, a device can be configured to use a BLE or BLE-like communications protocol to achieve transfer of a total payload that exceeds a payload capacity of pre-pairing/pre-bonding packets without the device entering into a paired/bonded relation with a recipient or source of that payload. Such transfer without entering into a paired/bonded relation may be referred to as a connectionless transfer of the payload, and/or as transfer of the payload during a connectionless state. In some implementations described herein, such connectionless transfer of such a payload (whether or not the total payload exceeds the payload capacity of the connectionless state) may be used to provide verification of a user for an aerosol provision device. This may be achieved utilising a user device, which may be a mobile device or other similar communication device, which user device is used to communicate with the aerosol provision device (or locked device) during the unlock process. Such a process uses a request from the mobile device to the locked device to unlock, prior to use by a user of the locked device.

In examples described herein, aerosol provision devices communicate with a mobile device. The communication disclosed utilises a connectionless state. Communication protocols with such states may therefore be used with the approaches disclosed herein. In particular, the approaches utilise advertising and scanning modes for information exchange. Therefore communication protocols with such modes may be used with the approaches disclosed herein.

The communication used in the approaches may be via a BLE protocol, but other Bluetooth protocols or Bluetooth-like protocols can also take advantage of the present teachings. Bluetooth is a wireless technology standard for short distance communication between appropriately enabled devices. BLE is a variant on the original Bluetooth system, designed to draw less power in use for extended battery life and/or small battery applications. Both Bluetooth and BLE operate in the UHF radio industrial, scientific and medical (ISM) band from 2.4 to 2.485 GHz and are designed for creating so-called wireless personal area networks (PANs) for interconnecting devices over short distances. BLE uses a modified version of the Bluetooth stack for communication such that a BLE device and a traditional Bluetooth device are not directly compatible unless one device implements both protocols. Both Bluetooth and BLE standards are maintained by the Bluetooth Special Interest Group (SIG). The present disclosure is provided in the context of a BLE implementation using the part of the Bluetooth v5 specification that relates to BLE (including BLE 5.1, 5.2, 5.3 etc). However, the skilled reader will appreciate that the present teachings can be applied to other Bluetooth approaches, such as the so-called Classic Bluetooth definitions that are also set out in the Bluetooth v4 specification. It will be further appreciated that the present teachings can be applied to technologies that are not in accordance with an entire Bluetooth specification, but which nevertheless behave in a Bluetooth-like manner.

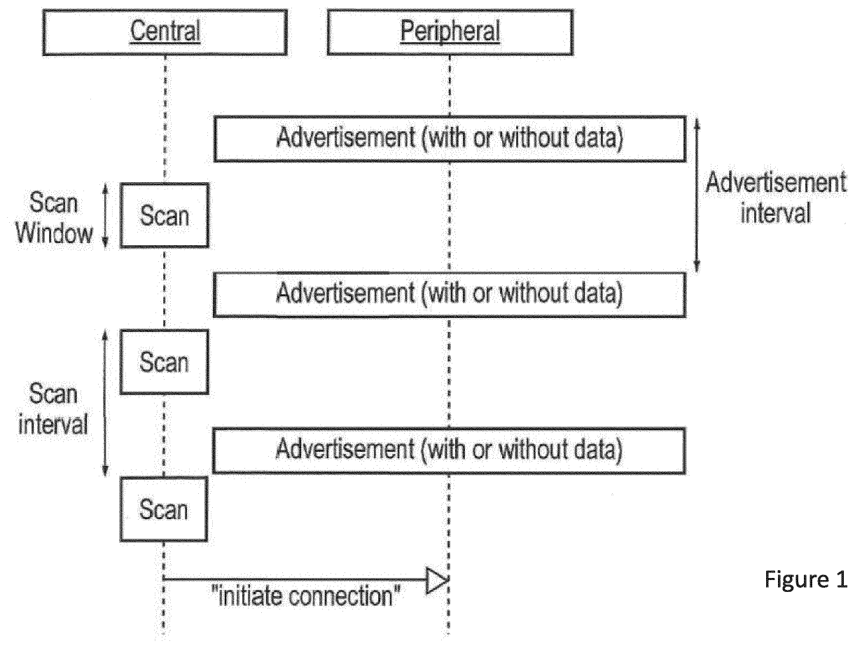

For example, non-Bluetooth systems that nevertheless use an advertising setup based on the BLE Generic Access Profile (GAP) and thus have an advertising structure substantially as set out in FIG. 1 would be able to deploy the techniques of the present teachings. FIG. 1 illustrates an advertising structure according to which a peripheral (or slave or remote or secondary) device advertises its availability as a peripheral (or slave or remote or secondary) device during an advertisement period, with the advertisement periods being separated by an advertisement interval. The advertisement may include data for transmission, an indication that there is data for transmission or have no data reference at all. To receive the advertisement, a central (or primary or control) device scans for advertisements during a scan window. Multiple scan windows are separated by a scan interval. The relative duration of the scan and advertisement intervals is altered, either by determining that the interval at one device type is constant while the other varies, or by determining that both vary, which determination can be set by a standard or rule set for implementing the advertising protocol. By providing this relative variation in the scan and advertisement intervals, it is provided that even where an initial advertisement period does not overlap with an initial scan window, after a number of advertisement and scan intervals, an advertisement period will occur which overlaps with a scan window such that a connection can be initiated between the central and the peripheral device.

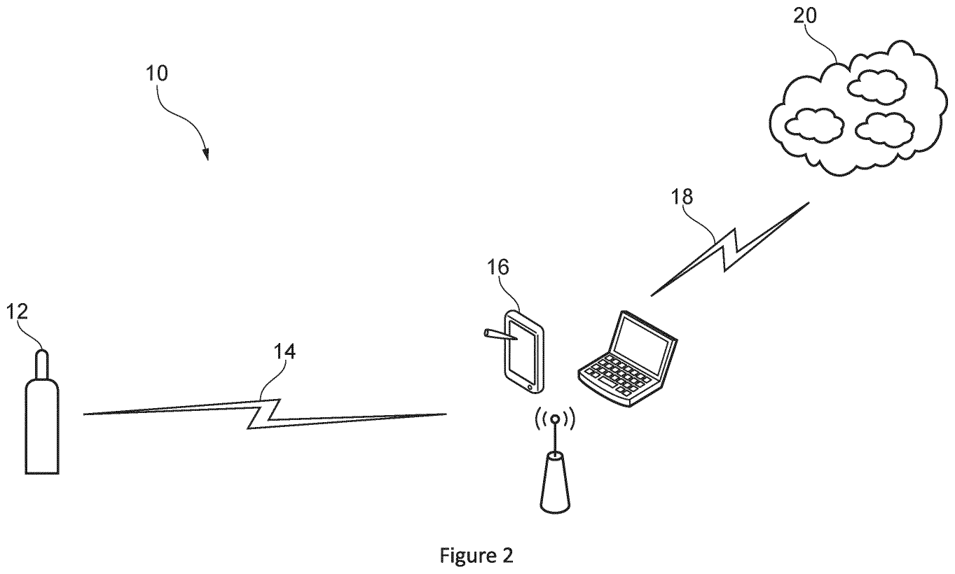

A first example of a devices environment 10 in which the present teachings can be utilised is shown in FIG. 2. In this example, an aerosol delivery device 12 (which may be a locked device 12) is operable to communicate with a user device 16 (which may be a user's mobile device 16) via a communication channel 14. Further, in some examples, the user device 16 may be operable to communicate via a communication channel 18 with a remote network service 20.

As discussed above, the aerosol provision device 12 may be an END device. The user device 16 may be any suitable device having compatibility with the wireless communication channel 14 (such as a user mobile device or the like). As illustrated in FIG. 2, the user device 16 may for example comprise a computing device such as a tablet computer, smartphone, portable computer, desktop computer, server or other multipurpose computing device including or attached to an interface for the wireless communication channel 14.

In an example, the wireless communication channel 14 is a BLE or BLE-like channel which transfers data packets between the aerosol delivery device 12 and the user device 16 using a connectionless state of a communication protocol or a connectionless communication protocol.

The communication channel 18 between the user device 16 and the remote network service 20 may be a wired and/or wireless channel and may use the same or different network protocols as the wireless communication channel 14. In the present examples, the communication channel 18 may be a conventional network data connection such as a WI-FI (IEEE802.11x) or Ethernet-based connection, for example using conventional network transport and data protocols such as TCP/IP, Fiberchannel and Infiniband.

The remote network service 20 may be accessed via a public or private network such as a WAN or the Internet. The remote network service 20 may be provided on dedicated or shared network resources as a public or private cloud service.

Using the structure illustrated in FIG. 2, the aerosol delivery device 12 may exchange data or messages with the one or more user devices 16 using a connectionless transmission arrangement, i.e. without a formal bonding, pairing or other connection establishment process. This may facilitate straightforward and non-intrusive requesting and provision of data to and from the aerosol delivery device 12. Therefore, the user device 16 can communicate with the aerosol provision device 12 and make requests such as unlock requests. In response, the aerosol provision device 12 may request verification of the user of the user device 16. Accordingly, the user device 16 may communicate with the remote service 20, which may be a secure server owned by a trusted party. The user device 16 may access an unlock code from the secure server 20 and provide this to the aerosol provision device 12. In response, the aerosol provision device 12 may unlock and enable the user of the mobile device 16 to use the aerosol provision device 12.

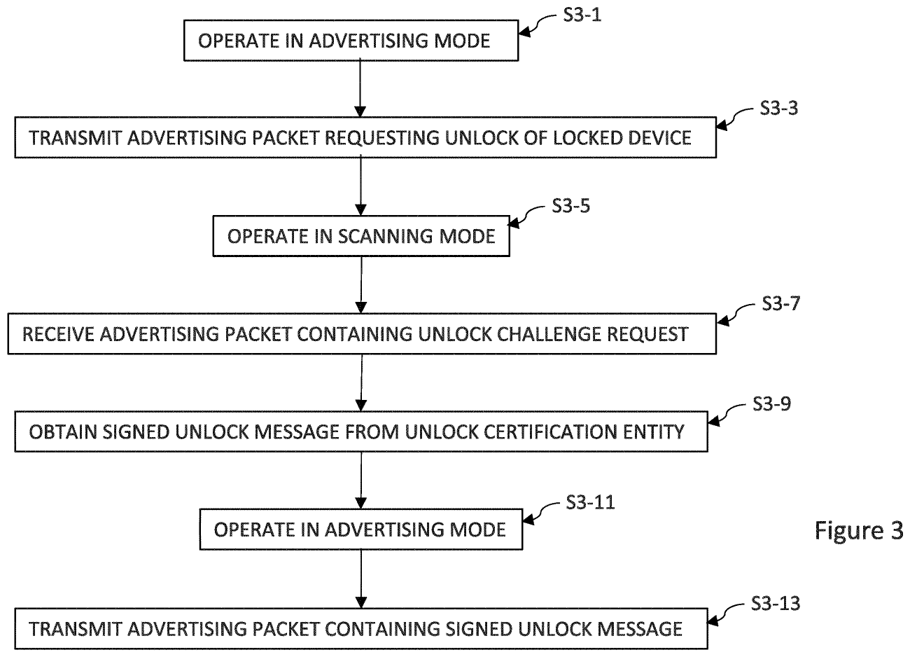

An approach for sending and receiving data packets between the elements illustrated in FIG. 2 is shown in FIG. 3. FIG. 3 shows, in the form of a flow diagram and from the perspective of activities of a user device, a method for providing an unlock signal to a locked device.

The steps performed in the method illustrated in FIG. 3 may be triggered in a number of ways. In one implementation approach, the method may be triggered by a user causing the user device to commence an unlock method. This could be achieved for example by the user having access to activate an unlock functionality in a software application or app operating on the user device. In this implementation approach, the method may be commenced without the user device having detected the presence of a locked device nearby. In another implementation approach, the method may be triggered by the user device receiving an advertising packet from the locked device requesting creation of a paired relation. In this implementation approach, rather than entering into an exchange (such as that illustrated in FIG. 1) to enter into a paired relation, the user device instead commences the method of FIG. 3 to perform an unlocking operation while in a connectionless state. For instance, to cause the locked device to commence an interaction with the user device that triggers the method of FIG. 3, a user of the locked device may perform one or more button presses (or other UI interactions) with the locked device.

As shown in FIG. 3, the method starts at step S3-1 with the user device operating, initially, in the advertising mode. The user device in the advertising mode then transmits (at step S3-3) an advertising packet requesting unlock of the locked device (e.g. an aerosol provision device). The user device then changes (at step S3-5) to operating in the scanning mode. In scanning mode, the user device receives at step S3-7 an advertising packet from the locked device (e.g. an aerosol provision device) containing an unlock challenge request. Upon receipt of this unlock challenge request, the user device then obtains at step S3-9 a signed unlock message from the unlock certification entity (such as a trusted server or the remote network service 20 of FIG. 2), as will be further described below. In response to receipt of this signed unlock message, the user device then changes at step S3-11 to operating in the advertising mode. Once operating in the advertising mode, the user device then transmits at step S3-13 an advertising packet containing the signed unlock message from the certification entity to the locked device.

In this way, the method shown in the example of FIG. 3 allows a user device to provide a verified unlock request to the locked device, using the trusted verification of a secure server or the like. Accordingly, there can be provided secure and reliable approach for enabling a locked device to be used only by authorised and/or suitable users, such as those that may be of a suitable age, or the specific owner (or owners) of the locked device. The secure server may retain any relevant data by which verification of the user of the mobile device may occur. Verification in this context is the act of ascertaining whether the user of the mobile device attempting to access the locked device is authorised to do so, or not. In this way, the unlock operation may be performed using a signed unlock message that provides authority to unlock the locked device as well as an indication of the authority to issue the unlock instruction, without the locked device or the user device needing to receive or store data that evidences the user's authority to receive the unlock message.

In step S3-9, a signed unlock message is obtained from the unlock certification entity. This step may involve authentication of the user device in some form, such as provision of login details or the like. Alternatively or additionally, this may occur via some form of credentials check between the user device and the certification entity. The credentials may be a digital signature.

The concept of a digital signature may be used in techniques described herein. A digital signature may be involved in methods of confirming that a piece of data, which in this case is a challenge, has been authorized by an entity whose identity can be verified. This involves applying a digital signature to the challenge, to ensure that the challenge is identifiable as being authorized by a particular source. In an example, the signing involves applying a digital signature to the challenge using the private key of a trusted source, and then, using the corresponding public key by the receiving entity, verifying this digital signature as having been applied by the expected trusted source. However, although an approach using asymmetric keys (with a private and public key) has been described here, other approaches may be used for the digital signature.

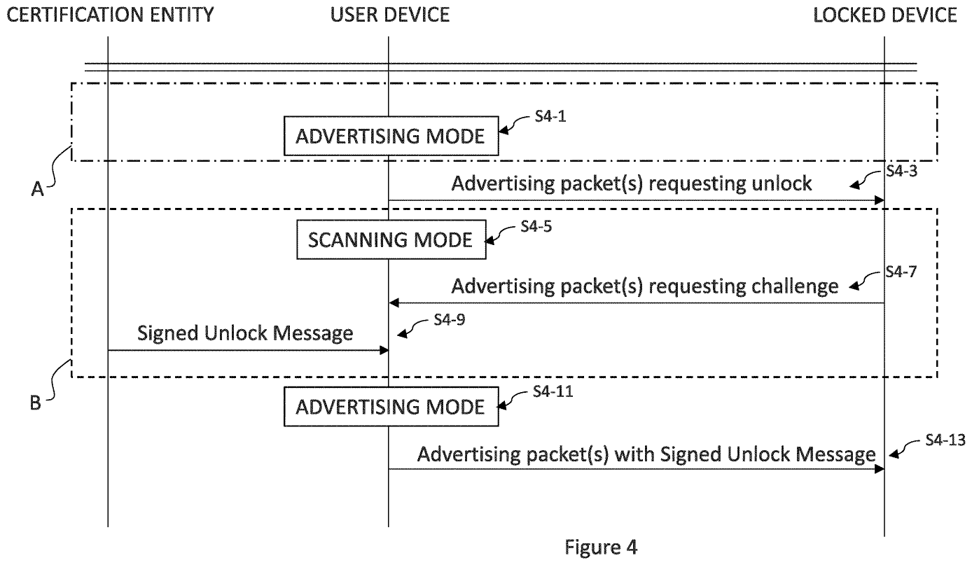

Referring now to FIG. 4 there is shown an example of a messaging sequence for the user device. The messaging sequence is shown with respect to the user (or mobile) device, the locked device (or aerosol provision device) and the certification entity (secure server or the like). The user device initially operates in the advertising mode, step S4-1. The advertising packet requesting unlock is sent to the locked device, step S4-3. The user device then switches to the scanning mode, step S4-5. In step S4-7, the user device receives the advertising packet (or packets) requesting a challenge to assess the suitability of the user to use the locked device. In step S4-9, the user device receives the signed unlock message from the secure “back end” of the certification entity. As mentioned above, step S4-9 may involve an authentication aspect of the user device so that the certification entity knows to send the signed unlock message to a trusted user device. Authentication data may be contained in the challenge from the locked device, which the user device may provide to the certification entity. After receipt of the signed unlock message, the user device switches to advertising mode, S4-11, and provides the advertising packet (or packets) with the signed unlock message in step S4-13. In this way, the user device may securely and verifiably request access for the user of the user device of the locked device.

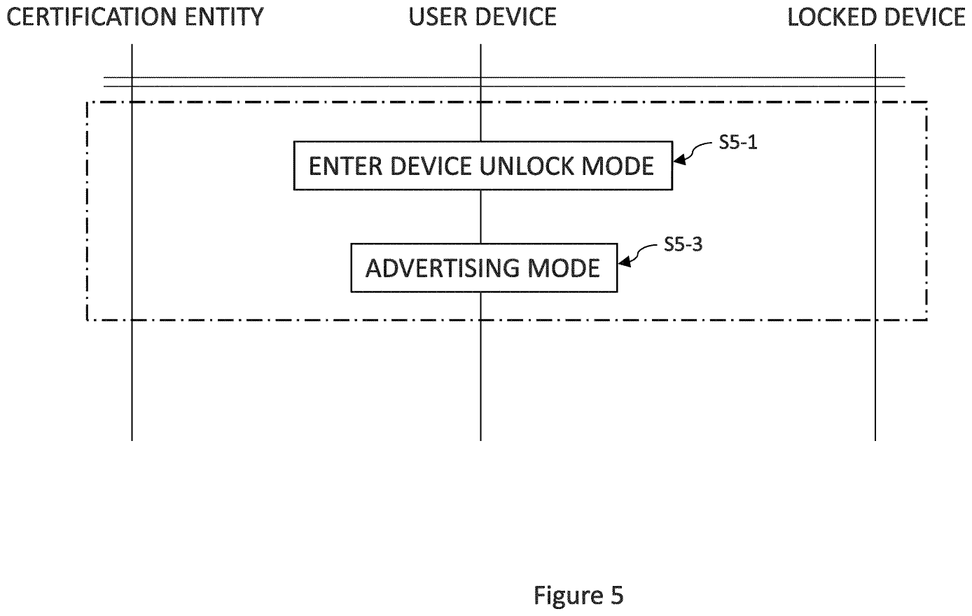

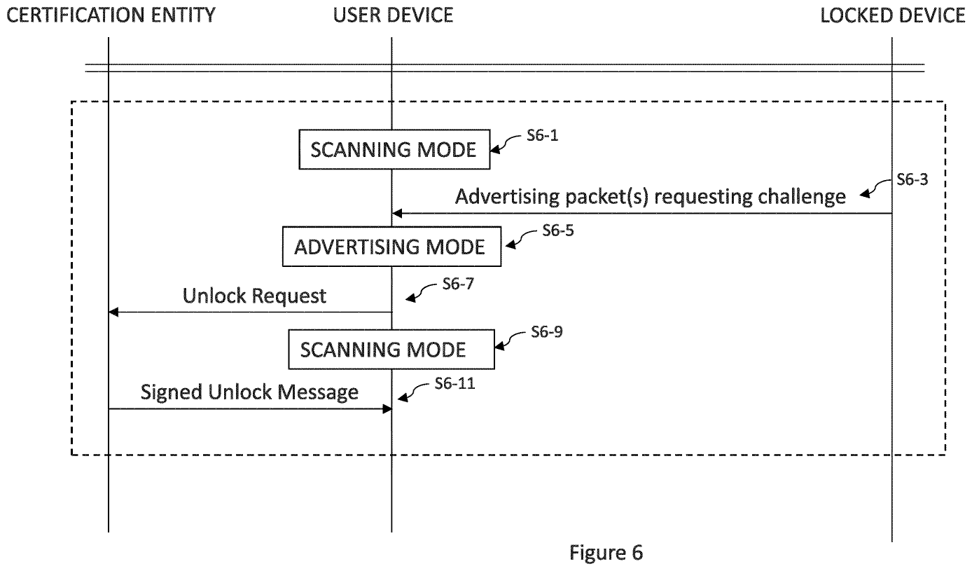

FIG. 4 has two portions indicated A and B. These are portions of the messaging sequence that are shown in greater detail in FIGS. 5 and 6. Portion A is the initial portion of the sequence and is shown in a dash-dot box. Portion B is a later portion of the sequence and is shown in a dash box.

Referring now to FIG. 5 there is shown a detailed view of portion A of FIG. 4. Specifically, in the example of FIG. 5, portion A is shown as including a step of entering a device unlock mode at the user device in step S5-1. The user may access the user device and enter the device into a device unlock mode by inputting a code or by verification of the user by, e.g., fingerprint or face recognition the like. When the user is recognised by the user device in the method included herein, this provides an additional preventative step to unauthorised users accessing the locked device. As such, in a specific example step 5-1 may be completed only by an authorised user thereby improving the robust security offered by the unlock method.

The user enters the user device into an unlock mode, step S5-1, which may be prior to the device entering the advertising mode, in step S5-3. This also reduces the battery usage of the user device, as the user device need only enter the advertising mode and subsequently provide signals to nearby locked devices once the user of the user device has requested it to do so. This therefore provides an increased efficiency in the process described herein.

Referring now to FIG. 6 there is shown a detailed view of portion B of FIG. 4. Specifically, in the example of FIG. 6, portion B is shown as including additional swapping steps of the user device entering advertising mode and then switching to scanning mode. The user device is in scanning mode at step S6-1. In scanning mode, the user device receives advertising packet requesting a challenge at step S6-3. The switch from scanning mode to advertising mode, step S6-5, occurs between the receipt of the advertising packet (or packets) from the locked device, step S6-3, and the sending of the unlock request to the certification entity, step S6-7. After the sending of the unlock request to the certification entity in step S6-7, the user device enters the scanning mode, step 6-9. The user device then receives a signed unlock message from the certification entity at step S6-11. In this manner, the method allows for the user device to elicit a response from the certification entity via the advertising and scanning modes.

The arrangement in FIG. 6 is not essential. The user device may be connected to the certification entity via a WI-FI connection or the like and therefore there would be no requirement for the switch between advertising and scanning modes as shown in FIG. 6. FIG. 6 enables the uses of connectionless state communication between the user device and the certification entity. The request and unlock message sent in FIG. 6 may contain identifiers to allow the messages to be associated with the correct device or devices. The unlock request sent by the user device may include a certification step such that the certification entity is informed the user device is associated with a user suitable to use the locked device.

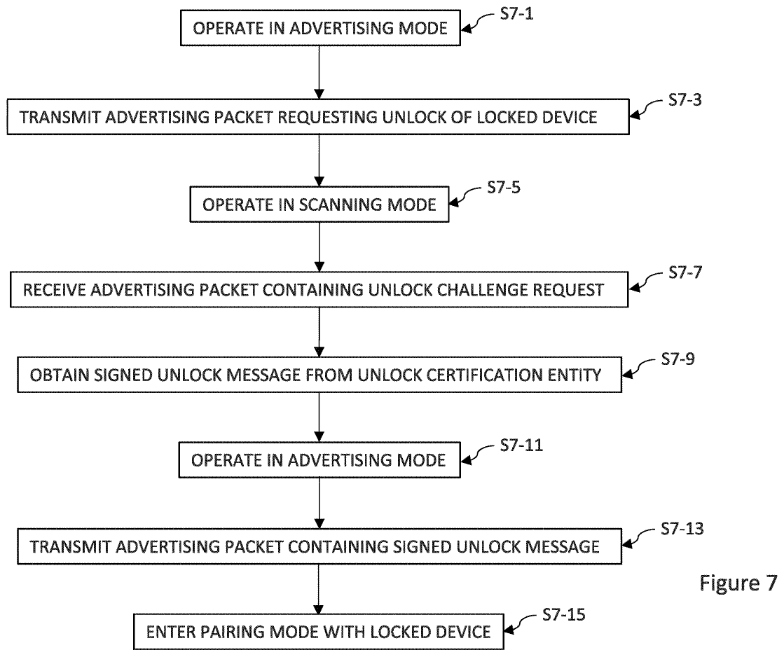

Referring now to FIG. 7, there is shown a method for communication between a user device and a locked device. The method shown in the example of FIG. 7 is similar to the method shown in the example of FIG. 3.

The method of FIG. 7 contains the steps of FIG. 3 (specifically the steps S3-1 to S3-13 are those indicated S7-1 to S7-13). The method of FIG. 7 also includes a further step, S7-15, of the user device, having unlocked the locked device, entering pairing mode with the locked device.

In this way, the locked device may be unlocked by a verified user using a verified user device. Once the locked device is satisfied of the verification or authorisation level of the user—sufficient to unlock the device—the “locked” device (the aerosol provision device that is now unlocked in the method) may pair directly with the user device. In this way, the subsequent communication between the user device and the aerosol provision device may be direct. Once in paired mode, the aerosol provision device (the now-unlocked “locked” device) may provide feedback to the mobile device (user device) in terms of operating conditions or use statistics or any relevant data or the like. Provision of such information may inform the user on whether the aerosol provision device requires specific handling such as refilling of consumable product, charging of battery or the like.

The disclosure herein utilises a connectionless state wherein devices are able to communicate without needing to maintain a direct link between the two devices. In a traditional “paired” approach, devices need to pair prior to sending messages. If this pairing is interrupted or difficult to maintain, the “paired” approach may be seen to provide a less robust service, as a completely reliable pairing cannot be provided. In the present system, a pairing is not required and the data will be transferred. As such, the connectionless technique disclosed herein can be more reliable in circumstances that pairing is difficult, for example, when at least one of the devices attempting to pair is in motion. Furthermore, there are electrical savings when pairing is not required. Bluetooth connection needs power to establish and maintain, these are not required in the present method. The present approach is particularly advantageous for an unlock of an aerosol provision device or the like. Such an unlock method may be used when first using the device, such as on sale or the like, and the unlock criteria may include specific approaches or requirements to satisfy unlock of the device. Similarly, the user device may be in the control of the manufacturer of the device such that the aerosol provision device (or similar age restricted device) may be unlocked only by a vendor who is satisfied that the purchaser is of a suitable age.

There has been described above a method for providing an unlock signal to a locked device for use by a user device. While this method has been shown in the example of an unlock approach, many other functions may be provided with this method. For example, the updating software or firmware of a device may occur using the communication method disclosed here. The functionalities of the device may be enabled or disabled remotely via updates from the manufacturer. This may allow the manufacturer to improve the safety of use of a device (locked or otherwise) without requiring a user to bring a device to a store or the like for handling by the store team. This in turn improves the user experience of the device, by providing fewer constraints on maintaining safe usage of the device.

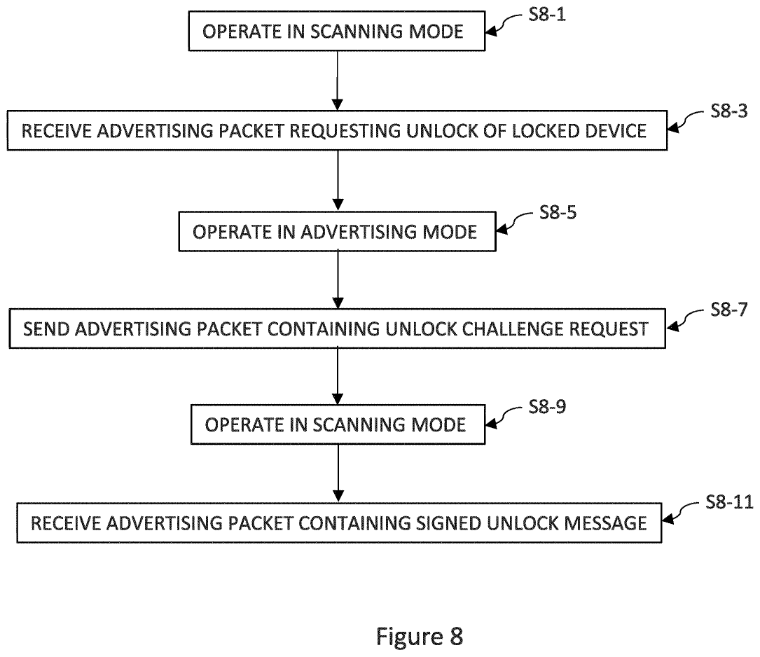

Referring now to FIG. 8 there is shown a method represented as a flow diagram. FIG. 8 shows a method for receiving an unlock signal by a locked device. The method shown is that for the locked device.

The method shown utilises operating the locked device, initially, in the scanning mode, step S8-1. The locked device in the scanning mode receives an advertising packet requesting unlock of the locked device (as explained above this may be an aerosol provision device), step S8-3. The locked device then changes to operating in the advertising mode in step S8-5. In advertising mode, the locked device sends an advertising packet to the user device (e.g. an mobile device) containing an unlock challenge request in step S8-7. In response to this, the locked device then changes to the scanning mode in step S8-9. The locked device then receives an advertising packet containing a signed unlock message from the user device in step S8-11.

As explained above, the signed unlock message originates from a trusted server that is in communication with the user device requesting the locked device to unlock. The locked device is able to recognise the authority of the trusted server and therefore is aware that self-unlocking is required and also, in light of the authorised user making the request, suitable.

This method is a reliable and secure method of unlocking a device and advantageously takes account of connectionless-state communication avoiding complications that can occur from a break in connection during or shortly after a pairing attempt.

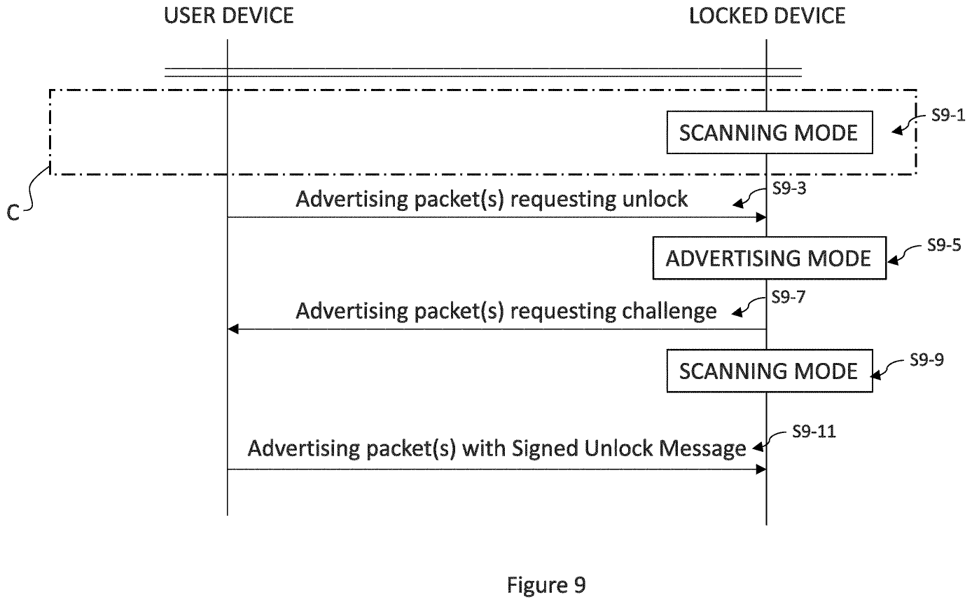

Referring now to FIG. 9 there is shown an example of a messaging sequence for the locked device. The messaging sequence is shown with respect to the user (or mobile) device and the locked device (or aerosol provision device). The certification entity (secure server or the like) shown in FIGS. 4, 5 and 6 are not included as the locked device does not directly communicate with the certification entity. The locked device operates in the scanning mode, step S9-1. An advertising packet (or packets) requesting unlock is received by the locked device from the user device, step S9-3. The locked device then switches to the advertising mode, step S9-5. The locked device sends an advertising packet (or packets) requesting a challenge to assess the suitability of the user to use the locked device, step S9-7. The locked device switches to scanning mode, step S9-9, and receives an advertising packet (or packets) with a signed unlock message, step S9-11. In this way, the locked device may securely and verifiably provide access to the locked device to the user of the user device.

Not shown in FIG. 9 is the communication between the user device and the certification entity. The locked device is able to ascertain the signed unlock message from the user device is authentic and is from the certification entity. In this way, the above connectionless communication is secure and reliable.

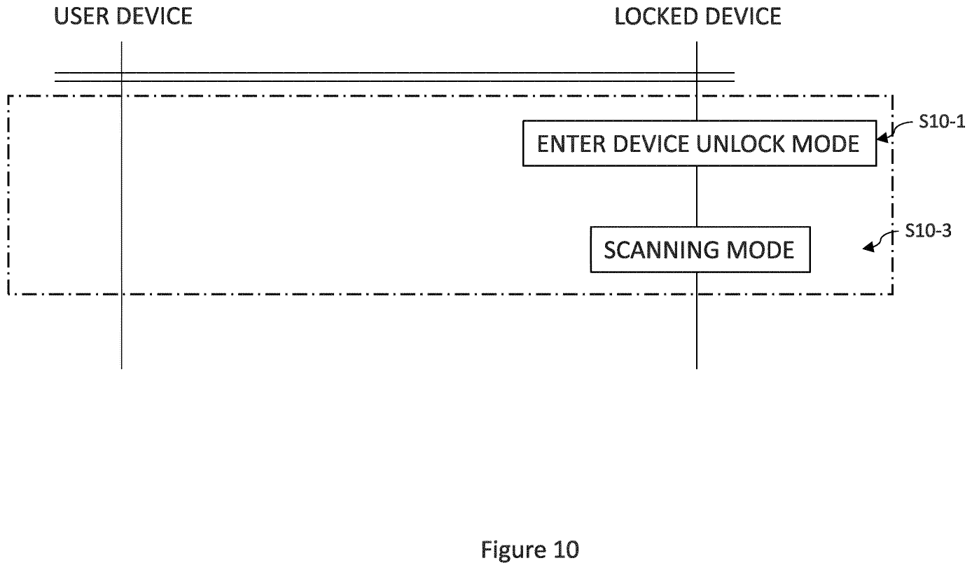

FIG. 9 has a portions indicated C. Portion C of the messaging sequence of FIG. 9 is shown in greater detail in FIG. 10. Portion C is the initial portion of the sequence and is shown in a dash-dot box.

Referring now to FIG. 10, there is shown a detailed example of portion C shown in FIG. 9. Specifically, in the example of FIG. 10, portion C is shown as including a step of entering a device unlock mode at the locked device, step S10-1. The user may request the locked device enter an unlock mode by inputting a code or by verification of the user by, e.g., fingerprint or face recognition the like. Alternatively, the locked device may be requested to enter an unlock mode by a user puffing on the device or pressing an activation button prior to use. Such an activation step may be suitable for a less technologically complex aerosol provision device—such an aerosol provision device may not contain user detectors such as fingerprint scanners or infrared emitters and detectors for analysing the face of a user. This allows the present method to be used in a simpler and cheaper-to-produce aerosol provision device.

The user enters the locked device into an unlock mode which may be prior to the locked device entering the scanning mode (entering “unlock mode” may initiate “scanning mode”), entering scanning mode is shown in step S10-3. This step can reduce the battery usage of the locked device, as the locked device need only enter the scanning mode and subsequently scan for and receive signals from nearby user devices (or device) once the user of the locked device has requested it to do so. This therefore provides an increased efficiency in the process described herein.

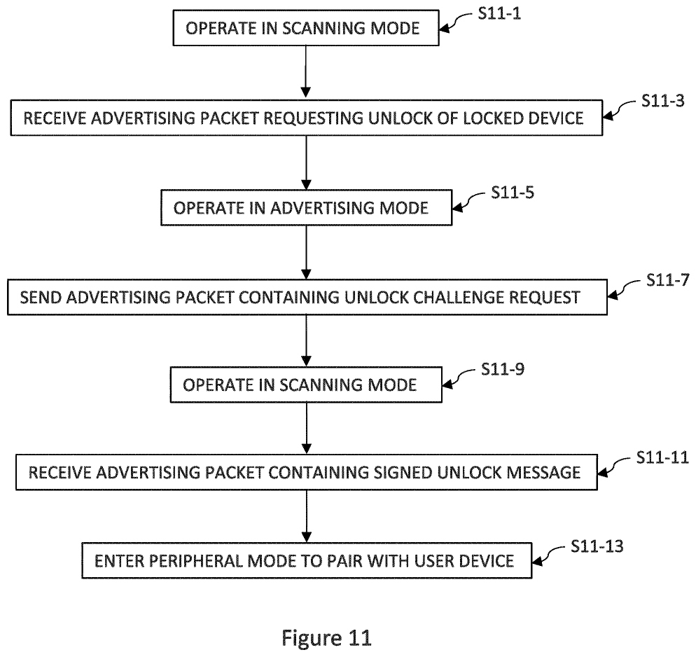

Referring now to FIG. 11, there is shown a method for communication between a locked device and a user device. The method shown in the example of FIG. 11 is similar to the method shown in the example of FIG. 8.

The method of FIG. 11 contains the steps of FIG. 8, specifically steps S8-1 to S8-11 are steps S11-1 to S11-11. The method of FIG. 11 also includes a further step, step S11-13, of the locked device, having received the advertising packet containing the signed unlock message from the user device, entering peripheral mode to pair with the user device.

In this way, the locked device may unlock when requested to by a verified user using a verified user device in a connectionless-state manner. Once the locked device is satisfied of the verification or authorisation level of the user—sufficient to unlock the device—the “locked” device (the aerosol provision device that is unlocked by the present method) may pair directly with the user device, i.e. enter peripheral mode so as to pair with the user device.

In this way, the subsequent communication between the user device and the aerosol provision device may be direct. Once in paired mode, the aerosol provision device (the now-unlocked “locked” device) may provide feedback to the mobile device (user device) in terms of operating conditions or use statistics or the like. Provision of such information may inform the user on whether the aerosol provision device requires specific handling such as refilling of consumable product, charging of battery or the like.

There has been described above an approach for securely unlocking a locked device for use by an authorised user of a user device.

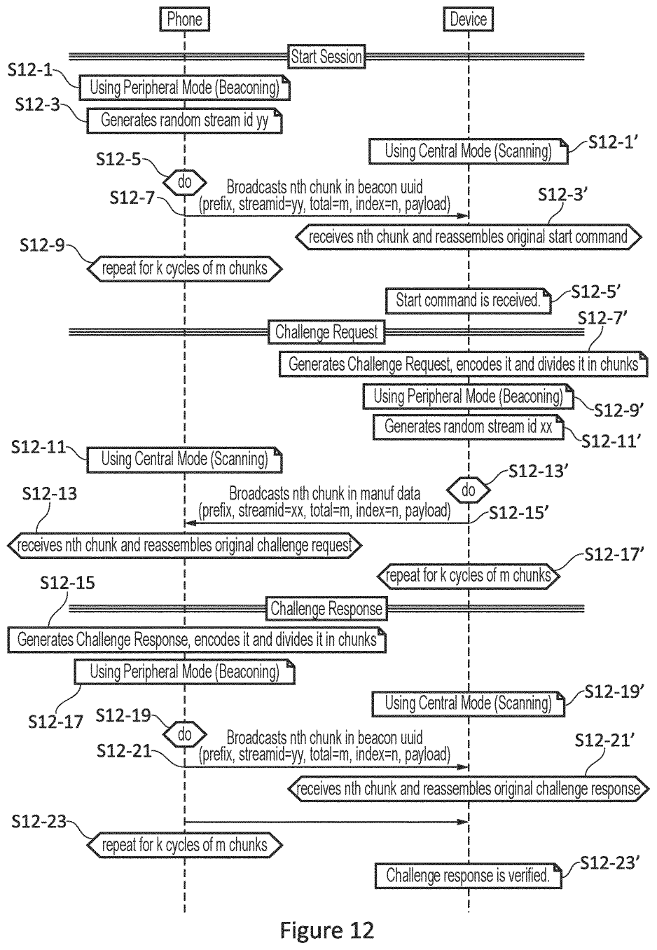

Referring now to FIG. 12, there is shown a messaging sequence for a phone (a user device) and a device (which may be the “locked device” of the above examples) according to an example of the present disclosure. In the sequence, the start of the session is indicated by the “Start Session” box. The phone (user device) uses peripheral mode (also known as “beaconing” or “advertising mode”), step S12-1. The phone generates a random stream id in step S12-3. The stream id provides session identification to the protocol. In this way, the receiving end is provided with an understanding of what stage it is at and of how many stages there are in the present messaging sequence. The phone emits this in beaconing mode. The device (which may be the aerosol provision device or the “locked device” as referred to above) uses central mode (or “scanning” mode), step S12-1′. The phone sends a message via beaconing and this is received by the device. In FIG. 12 this is shown by the broadcast of the “nth chunk in beacon”, step S12-7. The example of FIG. 12 considers a situation wherein the message to the device is large and may require several messages or chunks of information within a payload. The device in the example of FIG. 12 receives these chunks and reassembles the original message, step S12-3′. In FIG. 12, the original message is a start command to the device.

The random stream ID may first be generated by the user device, which may be a mobile device such as a mobile phone or the like. The random stream ID may be first generated by an app on the user device. This is sent to the locked device, which may be an aerosol provision device. In response, the aerosol provision device increments the random stream ID by one and then emits a message in response to receiving a message with the first random stream ID. Each communication may then be accompanied with a random stream ID which has in turn been incremented by 1. In this way, both devices are aware at which stage of communication the other device is. This assists in reducing the likelihood of cross talk or mixed communications.

Use of stream id assists one locked device in understanding that it is at stage 4 of 6, while assisting another device to understand that it is at stage 2 of 6. In this way, multiple “locked” devices may be provided data from one advertising mode device, without each “locked” device overlooking data or not receiving all the relevant data. A different stream ID may be provided in a message from the user device (or app thereon) to the locked device as to the locked device to the user device (or app thereon).

This technique may be implemented by using manufacturer data within advertisement packages. This technique may alternatively or additionally be implemented by using UUID to encode messages (which can be performed symmetrically) and transmit data piggybacking on the manufacturer data.

The use of UUIDs in this manner is highly unconventional. In particular, implementing this approach on both the user device and the locked device is unconventional. In conventional approaches, the UUID may be used, in effect, as a tag or title within a message. In the present method, the UUID can be manipulated to contain content. The content can be input into the envelope and use the UUID to encode the data. This technique can be done symmetrically or asymmetrically. For improved safety however, it may be preferable for one of the devices, such as the locked device, to not communicate in this manner.

The phone broadcasts, in step S12-9, messages with chunks, as required, for a scanning mode device to receive and reassemble the original full message—which has been broken into said chunks i.e. portions of the full data payload. The device may send the message inside the “Manufacturer Data” field of an advertisement beacon (or beacons). The phone, when communicating with the device may utilise an app or the like. The messages to the device may be encoded as part of an ad-hoc 128 bits UUID, with the following syntax:
UUID: ‘7468696e-$streamId-$seqnum$totlen-$payload[0-1]-$payload[2-7]’
   32 bits: fixed prefix to be used for matching
   64 bits: payload
   8 bits: seqnum (sequence number)
   8 bits: total length (number of chunks)
   16 bits: stream id (pseudo random generated by the beacon, to tell apart possible streams)

In response to the device reassembling the original full message, the start command is received, step S12-5′. The device then provides a challenge request, in step S12-7′, to ascertain that the user of the phone is a verified or authorised user. In the example of FIG. 12, this involves generating a challenge request. This request may be encoded and divided into chunks, as appropriate. In response to generating the challenge request, the device uses the peripheral mode (beaconing mode), step S12-9′. In this mode, the device emits the request. The device generates a random stream id, in step S12-11′. The phone uses the central mode (scanning mode), step S12-11. The phone therefore receives the messages emitted by the device, step S12-15′, specifically the phone receives the chunked message and reassembles the message into a challenge request from the device, step S12-13. As shown in FIG. 12, this can be done over multiple cycles for multiple chunks, step S12-17′. In this way, the phone receives the full original challenge request while in a connectionless-state.

The next portion of FIG. 12 is designated “Challenge Response”. In this section, the phone has communicated with the back end server (or, in another example, has the challenge response stored on the phone). The phone generates the challenge response, encodes it and divides into chunks, step S12-15. The phone then operates in peripheral mode to provide the chunks to the device, step S12-17, which is now in a central mode (scanning), step S12-19′. The phone broadcasts the chunks in a beacon using the format shown in step S12-21. The device receives the messages and reassembles the challenge response, step S12-21′. As mentioned above, this is repeated as many times as required for the full message to be provided to the device from the phone, step S12-23.

The device then verifies the challenge response from the phone, step S12-23′, and then the device may function according to the request. In the examples described above, the request is an unlock (and use) request. The device therefore unlocks, and is available for use. In other examples, this method may be used to provide software updates or the like to the device. Any other information exchange is possible, and this method is particularly advantageous in the event that the request is in some way sensitive or requires an authorisation check of the user making the request.

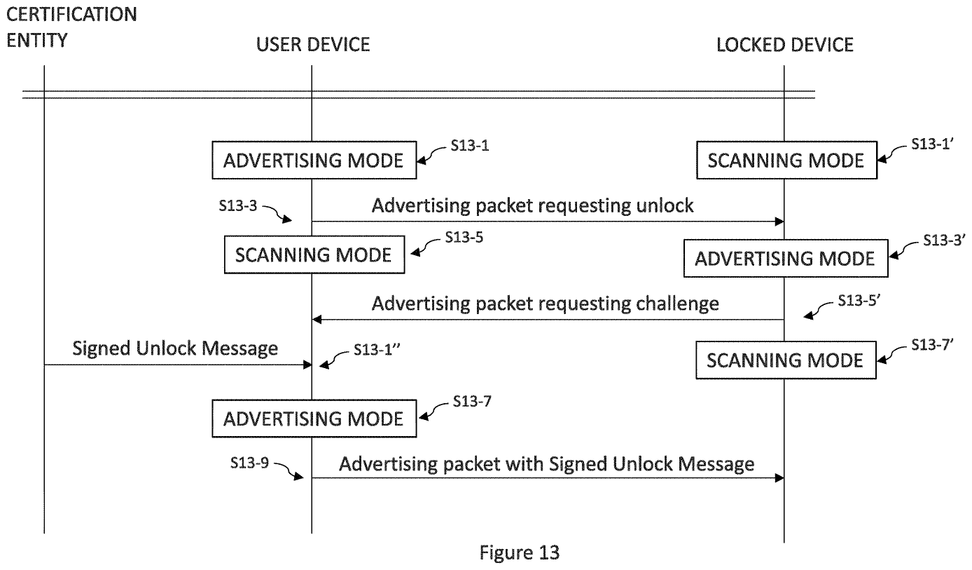

Referring now to FIG. 13 there is shown an example of a messaging sequence for a system comprising a certification entity, a user device and a locked device. The user device initially operates in the advertising mode, step S13-1, while the locked device operates in a scanning mode, step S13-1′. An advertising packet requesting unlock is sent to the locked device, step S13-3. The user device then switches to the scanning mode, step S13-5. The locked device receives the advertising packet and changes to advertising mode step S13-3′. The locked device sends, step S13-5′, an advertising packet (or packets) requesting a challenge to assess the suitability of the user to use the locked device. The locked device changes to scanning mode, step S13-7′. The user device receives a signed unlock message from the certification entity, step S13-1″. The user device switches to advertising mode, step S13-7, and provides the advertising packet (or packets) with the signed unlock message, step S13-9. In this way, the system assesses suitability of use of the locked device of the user of the user device. Furthermore, this can be achieved while maintaining a connectionless-state.

There is described herein therefore an approach for verifying a user in response to a use request of a locked device. In an example, the verifying of the user may be performed to assess an age of the user. This verification may be desirable where the locked device is providing access to an age restricted substance or the like. In the event that a user is of a suitable age for using the locked device, the device may unlock. As such, the approach disclosed herein may be used in an age verification protocol that utilises connectionless-state communication. The approach may use a cloud backend which is considered a trusted and non-hackable entity. The trusted and non-hackable entity signs a “challenge” token generated by the locked device to validate the “unlock” command sent by the user device (or phone). Such a technique is well suited for age verification of users wishing to use an aerosol provision device with age restricted products or consumables contained therein. The approaches herein do not rely on paired connection which can, as described above, be frustrating for a user during connection loss between devices.

The initiation of the age verification process, the user device, or the app operating thereon, may send an unlock request to the aerosol provision device (or locked device). The locked device may generate a challenge (e.g. 32 bytes) as a random number and may send the challenge to the user device or app, e.g. via BLE. The user device may send the challenge to the cloud backend. The cloud backend may return the message signed with a private key (96 bytes total) of the cloud backend.

After receipt of the signed challenge, the user device (or app), may relay the signed challenge to the locked device. The locked device holds the cloud backend public key and therefore assesses the signature for validity. Once verified by the locked device, the unlock action is considered validated and may be acted upon by the locked device.

As mentioned above, the present disclosure provides teachings of an approach of transfer of large information between devices that need not have a connection—i.e. while in a connectionless-state. While this has been applied to an unlock request in the examples shown, there is no need for such a restriction, rather this is a suitable example to illustrate a use of the present technique. Any transfer of information or data (including large size) can be performed in a connectionless-state by utilising the approach disclosed herein.

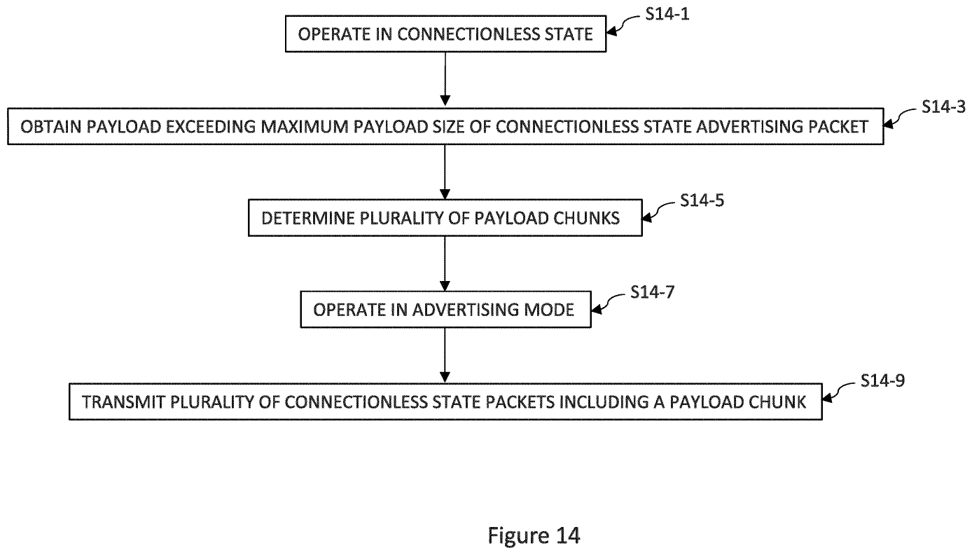

Referring now to FIG. 14, there is schematically shown an approach for transmitting a payload using a connectionless state packet. The approach begins by operating in a connectionless state, step S14-1; this is understood to mean no pairing of the devices between which the payload is to be transferred. One device obtains, step S14-3, a payload that exceeds a maximum payload size of a connectionless state advertising packet. The device determines, step S14-5, a plurality of payload chunks from the payload, each payload chunk having a size less than the maximum payload size. The device then operates in an advertising mode, step S14-7. The device then transmits, step S14-9, a plurality of connectionless state advertising packets, each connectionless state advertising packet including a chunk of the plurality of chunks, and an identifier of the chunk number.

In this way, a large payload may be delivered to one or more devices in scanning mode by the device operating to provide the large payload.

The use of “chunking” as described herein is highly advantageous as it allows for provision of payloads far larger than intended by the techniques used herein. Indeed, utilising the manufacturer data field of the advertisement beacons assists in the provision of large payloads to numerous devices.

In a specific example, this approach is performed using BLE advertisement messages broadcast without the two devices having previously established a one-to-one connection via BLE pairing (i.e. connectionless).

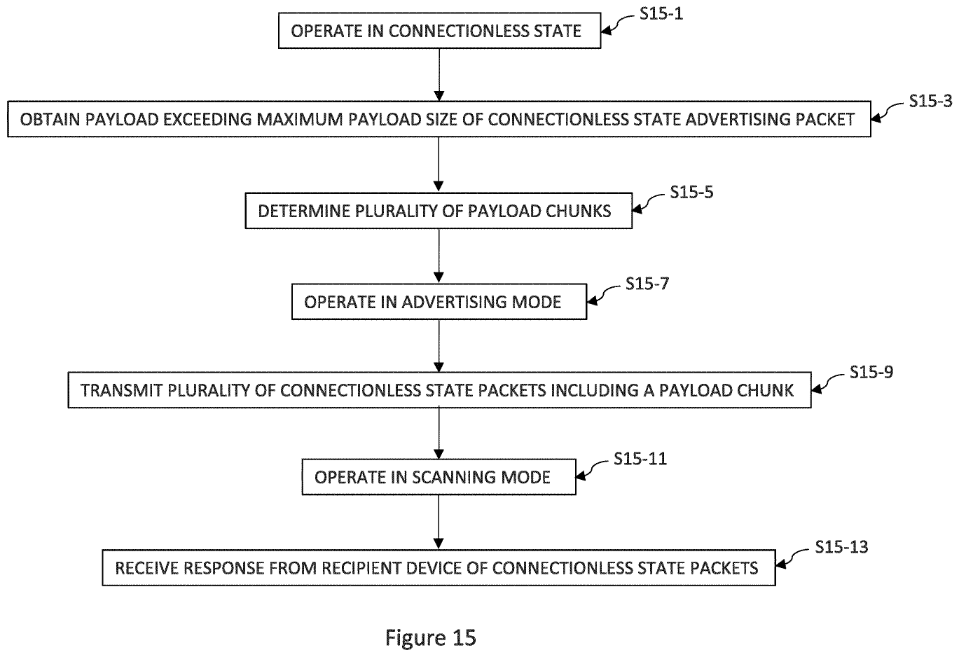

Referring now to FIG. 15, there is shown an approach for transmitting a payload using a connectionless state packet. The method shown in the example of FIG. 15 is similar to the method shown in the example of FIG. 14.

The method of FIG. 15 contains the steps of FIG. 14. In particular, the steps S14-1 to S14-9 of FIG. 14 are the steps S15-1 to S15-9 of FIG. 15. The approach shown in FIG. 15 also includes two further steps. First, the device, having transmitted the plurality of connectionless state packets including a payload chunk, in step S15-9, enters a scanning mode, in step S15-11. The device then receives, in step S15-13, a response from the recipient device (of the earlier advertising packets).

In this way, the recipient device may be provided with large payloads in a connectionless-state manner. This may include long-term operational data (for long term functioning or changes to function) as well as immediate operational data (such as a start command).

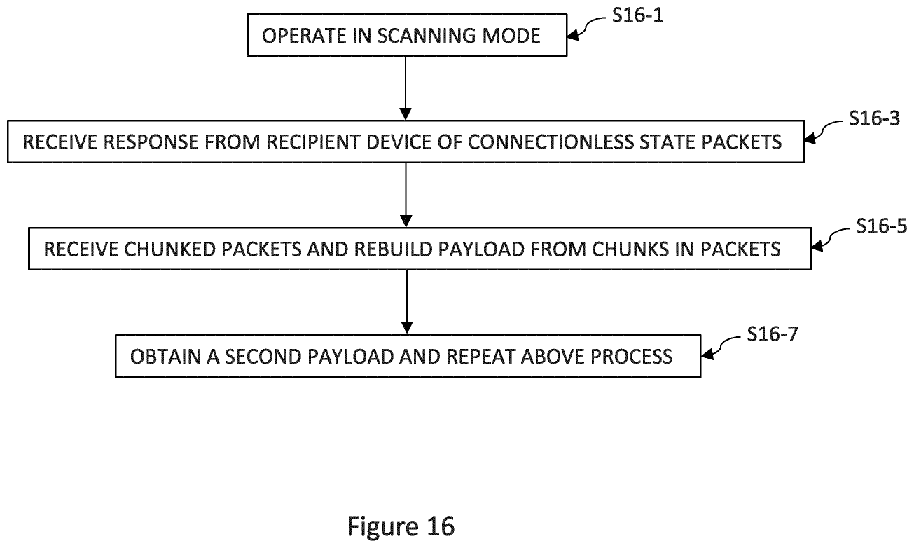

Referring now to FIG. 16, there is shown an approach of transferring data using a connectionless state packet. The approach of FIG. 16 contains some of the steps of FIG. 15. Specifically, FIG. 16 continues from the last steps of FIG. 15 of operating in a scanning mode and then receiving a response from the recipient device of connectionless state packets. The steps S15-11 and S15-13 are the steps S16-1 and S16-3 respectively.

The approach of FIG. 16 continues by receiving, in step S16-5, chunked packets and rebuilding, by the device, the payload from chunks in the packets from the recipient device. The device may then obtain, in step S16-7, a second payload for delivery to the recipient device and repeat the steps shown in the examples of FIGS. 14 and 15 as suitable. In this way, large payloads may be delivered to a recipient device entirely in a connectionless manner. This may allow the sending device to provide such payloads to multiple devices in one process, as each device receives the chunks, deciphers the order of the chunks, and reassembles the full payload accordingly. This is therefore a highly efficient method of data transfer. Large payloads may include firmware upgrades or the like. Such payloads are typically relatively large and would use a large number of chunks as described herein.

The approaches disclosed herein do not require an identifier of the device in any packets while advantageously using the advertising and scanning modes associated with techniques such as BLE. The approaches disclosed herein therefore remove the requirement for ID of device and pairing prior to user device-locked device handshake. Such requirements can render pairing vulnerable to hack attempts. As such, the approach disclosed herein provides improved security. The approaches are less time consuming in light of pairing issues -in a typical paired relationship if data transfer is interrupted and the pairing lost, the approach must re-pair and then re-send the full data. This is not the case in the present approach, which is more time efficient and robust in light of loss of connections.

The approaches disclosed herein may operate using any of the following, Bluetooth™, Bluetooth Low Energy™, ZigBee™, WiFi™, Wifi Direct™, GSM, 2G, 3G, 4G, 5G, LTE, NFC, or RFID. As mentioned above, the advertisements of Bluetooth™ and BLE may be exploited in the approaches of the present disclosure. A valid recipient can capture the messages sent from the user device.

The present approach also utilises an aerosol provision device in scanning mode, listening for messages from a potential beacon. This is advantageous and assists in the avoidance of direct pairing being required between the user device and the locked device. Acknowledgement messages are also not required in the present approach unlike in a typical pairing protocol. The lack of requirement of these messages reduces the number of messages between the user device and the locked device. As such, the present approach is a more efficient process of large payload transferral.

The verification technique herein may be used on a regularity that is deemed suitable by a manufacturer. In one example, the verification of a user may occur prior to each use session to ensure the user is authorised to use the device. In this way, while more time consuming and energy intensive, security of the device is prioritised. Conversely, the user may only be requested to verify themselves on initial use of the device. Once the user is verified the device may not require subsequent verification. In this example, user access and battery conservation is prioritised over security. Once the locked device is unlocked via the connectionless-state method, the locked device may handshake and pair with the user device, which may be used in future data transfer. Such an approach as described herein may therefore be once per lifetime of the locked device. In other examples, the approach may be used a plurality of times during the lifetime of the locked device.

In the example that the approach herein is used only once in the lifetime of the locked device, the approach may be repeated in extreme instances. Extreme instances may be a factory reset of the locked device, sale of the device or the like. This may be market specific decisions that can be taken by the manufacturer and triggered remotely via use of an app on a user device or the like.

The approach herein is advantageous in several aspects. Broadcasting in general allows unlock (or similar commands or the like) of many devices at the same time. Such commands may be configure a specific operation, provide or update data, query system operational capacity or the like. The approach is not limited to the functions or information that can be requested or transmitted. This is therefore a highly efficient approach for handling a large number of devices. The approach is very user friendly. The user is not required to take any action to perform the approach herein. While there are advantages (as described above) to user input, this is not required as it is in standard device-to-device pairing approaches. The approach may therefore occur in the background, away from the attention of the user. In this way, the transferral of operational data or the like required to use the device may occur without impacting the user experience of the “locked” device in any way.

In an addition to the presently disclosed approach, the approach may include a signal strength recognition step. In this way, a beaconing device may be preferentially connected to a scanning mode device where the signal strength is particularly high. Such a step may be used in a scenario wherein the user device wishes to communicate with nearby devices only. This may be used to filter messages from the local environment that are not intended for use with other “locked” devices. As such, the present approach can be used in a manner that is one to many, one to few, or one to one based on the use of an identify signal strength step.

Additionally or alternatively to the above point of differentiation being recognition of signal strength and according subsequent actions, a point of differentiation may be the input of one user against the input of another. As mentioned above, the user may put the device into scanning mode by pressing a button on the locked device. Differentiation may occur by one user pushing a button on their locked device a predetermined number of times, while a different user pushes a button on their locked device a different predetermined number of times. Differentiation may occur using button pushes, or other systems such as shaking or tapping a device that contains accelerometers or the like. A personalised activation code can thereby be used.

Alternatively, the number of pushes can be used to control the signal emission strength, such that e.g. a specific predetermined number of pushes enables a large group of locked devices to be included in the broadcast. This may be particularly suitable for use in, e . g., a demonstration at a manufacturer site (shop premises) or the like, where a large number of customer devices may be provided with a data update.

The technology used to implement the passing of data packets in a connectionless manner may be achieved a BLE communications environment. It is also possible to use alternative technologies to achieve a similarly connectionless transfer of data. As will be appreciated, BLE is a subset of the Bluetooth specifications, which were originally defined within the IEEE802.15 framework. Other IEEE802.15 compliant or derived technologies (sometime references as personal area network or PAN technologies) such as (non-BLE) Bluetooth (including Bluetooth 5, which no longer uses the “LE” designation), Zigbee or Z-Wave could be used to provide the connectionless transfer of the data. In addition, other wireless technologies such as Wi-FI (IEEE802.11n) or similar could be used to provide the connectionless transfer of the data.

Therefore, the present teachings have provided an approach for transmitting data to an aerosol provision device, receiving a challenge request, and responding. This is achieved without a need for device pairing or connection such that a user need not provide pre-configuration or ongoing interaction with the aerosol delivery device. The use of connectionless data transfer further avoids a need for user pre-configuration or ongoing interaction with the aerosol delivery device. At the same time, user configuration can be provided in specific implementations if appropriate.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the disclosure scope defined by the claims or limitations on equivalents to the claims, and that other embodiments may be utilised and modifications may be made without departing from the scope and/or spirit of the claims.

In a particular example, the locked device (or second device) disclosed herein may operate with a flavour pod which is replaceable in the device-this may be referred to as a consumable. The flavour may be any of tobacco and glycol and may include extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamon, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof.

When combined with an aerosol generating medium, the aerosol provision device as disclosed herein may be referred to as an aerosol provision system.

The aerosol provision system may be used in a tobacco industry product, for example a non-combustible aerosol provision system.

In one embodiment, the tobacco industry product comprises one or more components of a non-combustible aerosol provision system, such as a heater and an aerosolizable substrate.

In one embodiment, the aerosol provision system is an electronic cigarette also known as a vaping device.

In one embodiment the electronic cigarette comprises a heater, a power supply capable of supplying power to the heater, an aerosolizable substrate such as a liquid or gel, a housing and optionally a mouthpiece.

In one embodiment the aerosolizable substrate is contained in or on a substrate container. In one embodiment the substrate container is combined with or comprises the heater.

In one embodiment, the tobacco industry product is a heating product which releases one or more compounds by heating, but not burning, a substrate material. The substrate material is an aerosolizable material which may be for example tobacco or other non-tobacco products, which may or may not contain nicotine. In one embodiment, the heating device product is a tobacco heating product.

In one embodiment, the heating product is an electronic device.

In one embodiment, the tobacco heating product comprises a heater, a power supply capable of supplying power to the heater, an aerosolizable substrate such as a solid or gel material.

In one embodiment the heating product is a non-electronic article.

In one embodiment the heating product comprises an aerosolizable substrate such as a solid or gel material, and a heat source which is capable of supplying heat energy to the aerosolizable substrate without any electronic means, such as by burning a combustion material, such as charcoal.

In one embodiment the heating product also comprises a filter capable of filtering the aerosol generated by heating the aerosolizable substrate.

In some embodiments the aerosolizable substrate material may comprise an aerosol or aerosol generating agent or a humectant, such as glycerol, propylene glycol, triacetin or diethylene glycol.

In one embodiment, the tobacco industry product is a hybrid system to generate aerosol by heating, but not burning, a combination of substrate materials. The substrate materials may comprise for example solid, liquid or gel which may or may not contain nicotine. In one embodiment, the hybrid system comprises a liquid or gel substrate and a solid substrate. The solid substrate may be for example tobacco or other non-tobacco products, which may or may not contain nicotine. In one embodiment, the hybrid system comprises a liquid or gel substrate and tobacco.

In order to address various issues and advance the art, the entirety of this disclosure shows by way of illustration various embodiments in which the claimed invention(s) may be practiced and provide for a superior electronic aerosol provision system. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.

Each of the techniques taught herein as envisaged as operating within the framework of aerosol provision device and the like. While further technologies may be benefitted with the proposed methods and techniques, aerosol provision devices (aerosol generating devices) and the like have clear use characteristics that synergistically bond particularly well with the disclosed techniques.

During the communication techniques disclosed herein, the user device which may be a mobile communication device, is able to communicate to a broad array of locked devices (which may not be locked as described above, but rather in need of updating soft or firmware or the like). The user device may contain a mobile app or the like for controlling the signalling from the user device to the locked device. The user device, or mobile app thereon, may generate a stream ID at the beginning of communication. The stream ID may be incremented by 1 at each subsequent communication. In this way, the likelihood of cross talk issues at a later point of communication is reduced. The stream ID may be a large, distinct number that is newly generated for each session or period or the like of communication.

Avoiding cross talk improves the security and reliability of the techniques disclosed herein. In turn, this improves the user experience of the methods taught. A further method for avoiding cross talk relates to improving the removal of signals not intended for use by the locked device. The locked device may be arranged to ignore low strength signals as low strength signals may safely be presumed to not be relevant to the locked device. In more detail, the received signal strength indicator (RSSI) may provide a criteria by which to filter signals incoming to the locked device (or equally the user device). The RSSI signal strength will drop off with radial distance. This is a feature that is also complementary with Bluetooth communication, and allows distant devices to be removed from consideration. This cut off technique may be applied to either or both of the locked device and the user device.

To further improve reliability, the user may be asked to take an action in response to the first message of a chain of messages being received at the locked device. In this way, the reliability of the messaging is improved. In an example, the first message (or any specific message) sent by the user device (or mobile app thereon e.g.) may prompt the user to confirm that an indication of receipt has occurred in the locked device. In an example the indication of receipt may be that an LED, on the locked device, has lit up on the locked device. In this way, the use of an indication of receipt improves the likelihood that the correct locked device has been linked by the initial message from the user device. This improves the overall reliability of the methods disclosed herein and therefore improves user experience. Any indication may be used, tactile, vibrational, sound or the like. In an example, a randomly generated feedback may be provided to the user, which the user must verify on the user device. In this way, the intended device receives the messages from the user device. The indication may involve a different or varied series of colours, sounds or the like or a different flashing sequence etc. In contrast to a standard connected-status communication between two devices, the presently disclosed method can remove the user from needing to interact with the devices during initial pairing. As such, the communication in the presently disclosed methods can occur without any user interaction whatsoever. With the addition on the user taking some action 9as described above), this is still a reduced burden on the user than via standard paired communications, wherein the user often needs to take multiple actions across both devices. As such, the user experience of the messaging between two devices is improved.

The default status of the locked device may be controlled by the manufacturer to strike a balance between the safety of use of the locked device alongside and the ease of user for a valid user. In an example, the locked device may have a default status of either natively locked or unlocked. If the user buys a device, which may be natively locked or unlocked, then as part of the first step, the device may also respond back with a parameter which states either “natively locked” or “natively unlocked”. In this way, the user device may be informed via connectionless state packet communication that the locked device is either initially locked or unlocked. This may be indicated to the user accordingly.

The above technique may be particularly useful as requirements in different jurisdictions for the locked device may vary. As requirements vary it is advantageous for the manufacturer to have the locked device update their default status and inform the user device of this. This also ensures that the user device, or app thereon, may operate equally across many jurisdictions, not requiring the user to use a new user device or app for new jurisdictions. This in turn improves the user experience of the methods, devices and systems disclosed herein.

The present methods reduce requirements on the user by enabling connectionless state communication between a user device and a locked device (or the like). The locked device may be unlocked or updated without any requirements being placed on the user to enable this to occur. The user therefore is not interrupted in their use of the device and the user experience is improved over present systems.

Further examples of feature combinations taught by the present disclosure are set out in the following numbered clauses:
1. A method for providing an unlock signal to a locked device, the method comprising:
transmitting, by a user device operating in a wireless advertising mode, an advertising packet containing data requesting an unlock of a locked device;
receiving, by the user device operating in a wireless scanning mode, an advertising packet containing an unlock challenge request from the locked device;
obtaining, by the user device and from an unlock certification entity, a signed unlock message; and
transmitting, by the user device operating in the wireless advertising mode, an advertising packet containing data comprising the signed unlock message.
2. A method according to clause 1, wherein the advertising packets are connectionless state packets.
3. A method according to clause 1 or clause 2, wherein the transmitting and receiving steps occur via Bluetooth or Bluetooth Low Energy, BLE.
4. A method according to any preceding clause, wherein the advertising mode is BLE peripheral mode.
5. A method according to any preceding clause, wherein the scanning mode is BLE central mode.
6. A method according to any preceding clause, wherein each transmitting step is performed multiple times.
7. A method according to any preceding clause, wherein the data requesting an unlock of a locked device comprises a predetermined code to identify the payload as a message relating to unlocking of a locked device having a device type corresponding to a device type of the locked device.
8. A method according to any preceding clause, wherein the data requesting an unlock of a locked device comprises a code generated to distinguish the advertising packets from advertising packets generated by another user device or another locked device.
9. A method according to any preceding clause, wherein the data requesting an unlock of a locked device is larger than payload of a single advertising packet.
10. A method according to any preceding clause, wherein the data requesting an unlock of a locked device is divided over multiple advertising packets using approach provided by operating service or via wireless implementation of the user device.
11. A method according to any preceding clause, wherein the data requesting an unlock of a locked device is divided over multiple advertising packets using a 128 bits UUID message.
12. A method according to any preceding clause, wherein the unlock challenge request from the locked device comprises a predetermined code to identify the payload as a message relating to unlocking of a locked device having a device type corresponding to a device type of the locked device.
13. A method according to any preceding clause, wherein the unlock challenge request from the locked device comprises a code generated to distinguish the advertising packets from advertising packets generated by another user device or another locked device.
14. A method according to any preceding clause, wherein the unlock challenge request from the locked device fits within payload of a single advertising packet.
15. A method according to any of clauses 1 to 13, wherein the unlock challenge request from the locked device fits within payload of a two advertising packets.
16. A method according to any of clauses 1 to 13, wherein the unlock challenge request from the locked device is larger than payload of a single advertising packet.
17. A method according to any of clauses 1 to 13, wherein unlock challenge request from the locked device is divided over multiple advertising packets using an approach provided by one of an operating system or a wireless implementation of the user device.
18. A method according to any of clauses 1 to 13, wherein unlock challenge request from the locked device is divided over multiple advertising packets using a 128 bits UUID message.
19. A method according to any preceding clause, wherein obtaining a signed unlock message comprises sending a request to the unlock certification entity and receiving from the unlock certification entity the signed unlock message.
20. A method according to clause 19, wherein obtaining the signed unlock message is performed over computing network connection between user device and unlock certification entity.
21. A method according to any preceding clause, wherein the unlock certification entity is an age verification service entity.
22. A method according to any preceding clause, wherein data comprising the signed unlock message comprises a predetermined code to identify the payload as a message relating to unlocking of a locked device having a device type corresponding to a device type of the locked device.
23. A method according to clause 8, wherein data comprising the signed unlock message comprises the code generated to distinguish the advertising packets from advertising packets generated by another user device or another locked device.
24. A method according to any preceding clause, wherein data comprising the signed unlock message is larger than a payload of a single advertising packet.
25. A method according to any preceding clause, wherein data comprising the signed unlock message is divided over multiple advertising packets using an approach provided by one of an operating system or a wireless implementation of the user device.
26. A method according to any preceding clause, wherein data comprising the signed unlock message is divided over multiple advertising packets using a 128 bits UUID message.
27. A method according to any preceding clause, wherein the locked device is an aerosol generation device.
28. A method according to any preceding clause, wherein the user device is at least one of a: smartphone; a smart device; and, a personal computer.
29. A method according to any preceding clause, the method further comprising entering a device unlock mode at the user device before transmitting the advertising packet containing data requesting an unlock of a locked device.
30. A method according to any preceding clause, the method further comprising entering a device pairing mode after transmitting the advertising packet containing data comprising the signed unlock message.
31. A method according to any preceding clause, the method further comprising upon receipt of n chunks of a payload of n chunks:
generating a challenge request; and,
changing mode from advertising mode to scanning mode.
32. A method according to any preceding clause, the method further comprising upon receipt of challenge request changing mode from scanning to advertising.
33. A method of receiving an unlock signal by a locked device, the method comprising:
receiving, by a locked device operating in a wireless scanning mode, an advertising packet containing data requesting an unlock of a locked device;
transmitting, by a locked device operating in a wireless advertising mode, an advertising packet containing an unlock challenge request from the locked device;
receiving, by the locked device operating in a wireless scanning mode, an advertising packet containing data comprising a signed unlock message.
34. A method according to clause 33, wherein the advertising packets are connectionless state packets.
35. A method according to clause 33 or clause 34, wherein the transmitting and receiving steps occur via Bluetooth or Bluetooth Low Energy, BLE.
36. A method according to any of clauses 33 to 35, wherein the advertising mode is BLE peripheral mode.
37. A method according to any of clauses 33 to 36, wherein the scanning mode is BLE central mode.
38. A method according to any of clauses 33 to 37, wherein each receiving step is performed multiple times.
39. A method according to any of clauses 33 to 38, wherein the data requesting an unlock of a locked device comprises a predetermined code to identify the payload as a message relating to unlocking of a locked device having a device type corresponding to a device type of the locked device.
40. A method according to any of clauses 33 to 39, wherein the data requesting an unlock of a locked device comprises a code generated to distinguish the advertising packets from advertising packets generated for another locked device.
41. A method according to any of clauses 33 to 40, wherein the data requesting an unlock of a locked device is larger than payload of a single advertising packet.
42. A method according to any of clauses 33 to 40, wherein the data requesting an unlock of a locked device is divided over multiple advertising packets using approach provided by operating service or via wireless transmission.
43. A method according to any of clauses 33 to 40, wherein the data requesting an unlock of a locked device is divided over multiple advertising packets using a 128 bits UUID message.
44. A method according to any of clauses 33 to 43, wherein data comprising the signed unlock message comprises a predetermined code to identify the payload as a message relating to unlocking of a locked device having a device type corresponding to a device type of the locked device.
45. A method according to clause 40, wherein data comprising the signed unlock message comprises the code generated to distinguish the advertising packets from advertising packets generated for another locked device.
46. A method according to any of clauses 33 to 45, wherein data comprising the signed unlock message is larger than a payload of a single advertising packet.
47. A method according to any of clauses 33 to 46, wherein data comprising the signed unlock message is divided over multiple advertising packets using an approach provided by one of an operating system or via wireless transmission.
48. A method according to any of clauses 33 to 47, wherein data comprising the signed unlock message is divided over multiple advertising packets using a 128 bits UUID message.
49. A method according to any of clauses 33 to 48, wherein the locked device is an aerosol generation device.
50. A method according to any of clauses 33 to 49, wherein
receiving, by a locked device operating in a wireless scanning mode, an advertising packet containing data requesting an unlock of a locked device, comprises:
   receiving, by a locked device operating in a wireless scanning mode from a user device operating in a wireless advertising mode, an advertising packet containing data requesting an unlock of a locked device,
and
the user device is at least one of a: smartphone; a smart device; and, a personal computer.
51. A method according to clause 50, the method further comprising entering a device unlock mode at the user device before transmitting the advertising packet containing data requesting an unlock of a locked device.
52. A method according to any of clauses 33 to 51, the method further comprising entering a device pairing mode after receiving the advertising packet containing data comprising the signed unlock message.
53. A method according to any of clauses 33 to 52, the method further comprising upon receipt of n chunks of a payload of n chunks:
generating a challenge request; and,
changing mode from advertising mode to scanning mode.
54. A method according to any preceding clause, the method further comprising upon receipt of challenge request changing mode from scanning to advertising.
55. A method for providing an unlock signal to a locked device, the method comprising:
transmitting, by a user device operating in a wireless advertising mode, to a locked device operating in a wireless scanning mode, an advertising packet containing data requesting an unlock of a locked device;
receiving, by the user device operating in a wireless scanning mode, from a locked device operating in a wireless advertising mode, an advertising packet containing an unlock challenge request;
obtaining, by the user device from an unlock certification entity, a signed unlock message; and
transmitting, by the user device operating in the wireless advertising mode, to a locked device operating in a wireless scanning mode, an advertising packet containing data comprising the signed unlock message.
56. A user device comprising:
a wireless communication interface configured to transmit, a connectionless-state advertising packet containing data requesting an unlock of a locked device;
the wireless communication interface further configured to receive a connectionless-state advertising packet from the locked device containing an unlock challenge request; and
the wireless communication interface further configured to:
obtain, from an unlock certification entity, a signed unlock message; and
transmit a connectionless-state advertising packet containing data comprising the signed unlock message.
57. A locked device comprising:
a wireless communication interface configured to receive a connectionless-state advertising packet containing data requesting an unlock of the locked device;
the wireless communication interface further configured to transmit a connectionless-state advertising packet containing an unlock challenge request to a user device; and
the wireless communication interface further configured to:
receive a connectionless-state advertising packet containing data comprising a signed unlock message.
58. A locked device according to clause 57, wherein the locked device is an aerosol generation device.
59. A system comprising:
a user device comprising a wireless communication interface;
a locked device comprising a wireless communication interface;
an unlock certification entity;
wherein the system is configured to:
   send, from the user device operating in a wireless advertising mode to the locked device operating in a wireless scanning mode, a connectionless-state advertising packet containing data requesting an unlock of the locked device;
   send, from the locked device operating in a wireless advertising mode to the user device operating in a wireless scanning mode, a connectionless-state advertising packet containing an unlock challenge request to the locked device;
   receive, by the user device operating in a wireless scanning mode from the unlock certification entity, a signed unlock message;
   send, from the user device operating in a wireless advertising mode to the locked device operating in a wireless scanning mode, a connectionless-state advertising packet containing data comprising the signed unlock message.
   60. A computer readable medium comprising instructions that, when executed by a computer processor, perform the method of any of clauses 1 to 55.
   61. A method for transmitting a payload using a connectionless state packet, the method comprising:
   obtaining, by a device having a capability for connectionless state advertising, a payload that exceeds a maximum payload size of a connectionless state advertising packet;
   determining, by the device, a plurality of payload chunks from the payload, each payload chunk having a size less than the maximum payload size;
   transmitting, by the device in an advertising mode, a plurality of connectionless state advertising packets, each connectionless state advertising packet including a chunk of the plurality of chunks, and an identifier of the chunk number.
   62. A method according to clause 60, wherein each connectionless state advertising packet further comprises a code that identifies the packet as a packet conveying a payload chunk of the payload.
   63. A method according to clause 60 or 61, wherein each connectionless state advertising packet further comprises a number identifying the total number of payload chunks.
   64. A method according to any of clauses 60 to 62, wherein each connectionless state advertising packet further comprises a code generated to distinguish the advertising packets from advertising packets generated by another device.
   65. A method according to any of clauses 60 to 63, wherein transmitting each of the plurality of connectionless state packets comprises transmitting each of the plurality of connectionless state packets plural times.
   66. A method according to any of clauses 60 to 64, further comprising entering a scanning mode to receive a response from a recipient device of the connectionless state packets.
   67. A method according to any of clauses 60 to 65, further comprising
   receiving, by the device in a scanning mode, a response from a recipient device of the connectionless state packets.
   68. A method according to clause 66, wherein the response, received by the device in scanning mode, comprises:
   a payload that exceeds a maximum payload size of a connectionless state advertising packet, wherein the payload comprises:
      a plurality of payload chunks, each payload chunk having a size less than the maximum payload size.
   69. A method according to clause 67, wherein each connectionless state advertising packet of the response further comprises a code that identifies the packet as a packet conveying a payload chunk of the payload.
   70. A method according to clause 67 or 68, wherein each connectionless state advertising packet of the response further comprises a number identifying the total number of payload chunks.
   71. A method according to clause 69, wherein the received packets of the response are rebuilt by the device in scanning mode based on data comprising a payload chunk number of the packet.
   72. A method according to any of clauses 66 to 70, wherein, responsive to receiving the response,
   receiving further responses from the recipient device of the connectionless state packets.
   73. A method according to any of clauses 60 to 71, wherein the device is an aerosol provision device.
   74. A method for transmitting a payload using a connectionless state packet, the method comprising:
   obtaining, by a first device having a capability for connectionless state advertising, a payload that exceeds a maximum payload size of a connectionless state advertising packet,
   determining, by the first device, a plurality of payload chunks from the payload, each payload chunk having a size less than the maximum payload size;
   transmitting, by the first device in an advertising mode to a second device in a scanning mode, a plurality of connectionless state advertising packets, each connectionless state advertising packet including a chunk of the plurality of chunks, and an identifier of the chunk number.
   75. A method according to clause 73, wherein each connectionless state advertising packet further comprises a code that identifies the packet as a packet conveying a payload chunk of the payload from the first device to the second device.
   76. A method according to clause 73 or 74, wherein each connectionless state advertising packet further comprises a number identifying the total number of payload chunks.
   77. A method according to any of clauses 73 to 75, wherein each connectionless state advertising packet further comprises a code generated to distinguish the advertising packets from advertising packets generated by another device.
   78. A method according to any of clauses 73 to 76, wherein transmitting each of the plurality of connectionless state packets, by the first device in an advertising mode, comprises transmitting each of the plurality of connectionless state packets plural times.
   79. A method according to any of clauses 73 to 77, further comprising entering a scanning mode to receive a response from the second device.
   80. A method according to clause 78, further comprising
   responsive to receiving the plurality of payload chunks and rebuilding the plurality of payload chunks into the payload, entering, by the second device, an advertising mode,
   transmitting, by the second device, a response to the payload to the first device,
   receiving, by the first device in a scanning mode, a response from the second device.
   81. A method according to clause 79, wherein the response to the payload exceeds a maximum payload size of a connectionless state advertising packet, the method further comprising:
   determining, by the second device, a plurality of response payload chunks for the response payload, each response payload chunk having a size less than the maximum payload size;
   transmitting, by the second device in an advertising mode to the first device in a scanning mode, a plurality of response connectionless state advertising packets, each response connectionless state advertising packet including a chunk of the plurality of chunks, and an identifier of the chunk number.
   82. A device for transmitting a payload using a connectionless state packet comprising:
   a wireless communication interface,
   the wireless communication interface configured to:
   receive a payload that exceeds a maximum payload size of a connectionless state advertising packet;
   determine a plurality of payload chunks from the payload, each payload chunk having a size less than the maximum payload size; and
   transmit, by the device in an advertising mode, a plurality of connectionless state advertising packets, each connectionless state advertising packet including a chunk of the plurality of chunks, and an identifier of the chunk number.
   83. A device for receiving a payload using a connectionless state packet comprising:
   a wireless communication interface,
   the wireless communication interface configured to:
   receive, in a scanning mode, a plurality of connectionless state advertising packets, each connectionless state advertising packet including a chunk of the plurality of chunks, and an identifier of the chunk number,
   rebuild the received plurality of connectionless state advertising packets based on data comprising a payload chunk number of the packet.
   84. A system comprising:
   a first device comprising a wireless communication interface; and,
   a second device comprising a wireless communication interface;
wherein the system is configured to:
receive a payload, by the first device, that exceeds a maximum payload size of a connectionless state advertising packet;
determine, by the first device, a plurality of payload chunks from the payload, each payload chunk having a size less than the maximum payload size;
transmit, by the first device in an advertising mode to the second device in a scanning mode, a plurality of connectionless state advertising packets, each connectionless state advertising packet including a chunk of the plurality of chunks, and an identifier of the chunk number;
receive, by the second device in a scanning mode, the plurality of connectionless state advertising packets, each connectionless state advertising packet,
rebuild, by the second device in a scanning mode, the received plurality of connectionless state advertising packets based on data comprising a payload chunk number of the packet.
   85. A non-transitory computer readable medium comprising instructions that, when executed by a computer processor, perform the method of any of clauses 60 to 80.
   86. A method for providing an unlock signal to a locked device, the method comprising:
   transmitting, by a user device operating in a wireless advertising mode, an advertising packet containing data requesting an unlock of a locked device;
   receiving, by the user device operating in a wireless scanning mode, an advertising packet containing an unlock challenge request from the locked device.
   87. A method according to clause 85, wherein the locked device is an aerosol provision device.
   88. A method according to clause 85 or 86, wherein the user device is a mobile communication device.

1. A method for transmitting a payload using a connectionless state packet, the method comprising:
obtaining, by a device having a capability for connectionless state advertising, a payload that exceeds a maximum payload size of a connectionless state advertising packet;
determining, by the device, a plurality of payload chunks from the payload, each payload chunk having a size less than the maximum payload size;
transmitting, by the device in an advertising mode, a plurality of connectionless state advertising packets, each connectionless state advertising packet including a chunk of the plurality of chunks, and an identifier of the chunk number.

2. A method according to claim 1, wherein each connectionless state advertising packet further comprises a code that identifies the packet as a packet conveying a payload chunk of the payload.

3. A method according to claim 1, wherein each connectionless state advertising packet further comprises a number identifying the total number of payload chunks.

4. A method according to claim 1, wherein each connectionless state advertising packet further comprises a code generated to distinguish the advertising packets from advertising packets generated by another device.

5. A method according to claim 1, wherein transmitting each of the plurality of connectionless state packets comprises transmitting each of the plurality of connectionless state packets plural times.

6. A method according to claim 1, further comprising entering a scanning mode to receive a response from a recipient device of the connectionless state packets.

7. A method according to claim 1, further comprising
receiving, by the device in a scanning mode, a response from a recipient device of the connectionless state packets.

8. A method according to claim 7, wherein the response, received by the device in scanning mode, comprises:
a payload that exceeds a maximum payload size of a connectionless state advertising packet, wherein the payload comprises:
a plurality of payload chunks, each payload chunk having a size less than the maximum payload size.

9. A method according to claim 8, wherein each connectionless state advertising packet of the response further comprises a code that identifies the packet as a packet conveying a payload chunk of the payload.

10. A method according to claim 8, wherein each connectionless state advertising packet of the response further comprises a number identifying the total number of payload chunks.

11. A method according to claim 10, wherein the received packets of the response are rebuilt by the device in scanning mode based on data comprising a payload chunk number of the packet.

12. A method according to claim 7, wherein, responsive to receiving the response,
receiving further responses from the recipient device of the connectionless state packets.

13. A method according to claim 1 wherein the device is an aerosol provision device.

14. A method for transmitting a payload using a connectionless state packet, the method comprising:
obtaining, by a first device having a capability for connectionless state advertising, a payload that exceeds a maximum payload size of a connectionless state advertising packet,
determining, by the first device, a plurality of payload chunks from the payload, each payload chunk having a size less than the maximum payload size;
transmitting, by the first device in an advertising mode to a second device in a scanning mode, a plurality of connectionless state advertising packets, each connectionless state advertising packet including a chunk of the plurality of chunks, and an identifier of the chunk number.

15-18. (canceled)

19. A method according to claim 14, further comprising entering a scanning mode to receive a response from the second device.

20. A method according to claim 19, further comprising
responsive to receiving the plurality of payload chunks and rebuilding the plurality of payload chunks into the payload, entering, by the second device, an advertising mode,
transmitting, by the second device, a response to the payload to the first device,
receiving, by the first device in a scanning mode, a response from the second device.

21. A method according to claim 20, wherein the response to the payload exceeds a maximum payload size of a connectionless state advertising packet, the method further comprising:
determining, by the second device, a plurality of response payload chunks for the response payload, each response payload chunk having a size less than the maximum payload size;
transmitting, by the second device in an advertising mode to the first device in a scanning mode, a plurality of response connectionless state advertising packets, each response connectionless state advertising packet including a chunk of the plurality of chunks, and an identifier of the chunk number.

22. A device for transmitting a payload using a connectionless state packet comprising:
a wireless communication interface,
the wireless communication interface configured to:
receive a payload that exceeds a maximum payload size of a connectionless state advertising packet;
determine a plurality of payload chunks from the payload, each payload chunk having a size less than the maximum payload size; and
transmit, by the device in an advertising mode, a plurality of connectionless state advertising packets, each connectionless state advertising packet including a chunk of the plurality of chunks, and an identifier of the chunk number.

23. A device for receiving a payload using a connectionless state packet comprising:
a wireless communication interface,
the wireless communication interface configured to:
receive, in a scanning mode, a plurality of connectionless state advertising packets, each connectionless state advertising packet including a chunk of the plurality of chunks, and an identifier of the chunk number,
rebuild the received plurality of connectionless state advertising packets based on data comprising a payload chunk number of the packet.

24. A system comprising:
a first device comprising a wireless communication interface; and,
a second device comprising a wireless communication interface;
wherein the system is configured to:
receive a payload, by the first device, that exceeds a maximum payload size of a connectionless state advertising packet;
determine, by the first device, a plurality of payload chunks from the payload, each payload chunk having a size less than the maximum payload size;
transmit, by the first device in an advertising mode to the second device in a scanning mode, a plurality of connectionless state advertising packets, each connectionless state advertising packet including a chunk of the plurality of chunks, and an identifier of the chunk number;
receive, by the second device in a scanning mode, the plurality of connectionless state advertising packets, each connectionless state advertising packet,
rebuild, by the second device in a scanning mode, the received plurality of connectionless state advertising packets based on data comprising a payload chunk number of the packet.

25. (canceled)
